(19) United States
(12) Patent Application Publication
(10) Pub. No.: US 2007/0055662 A1
(43) Pub. Date: Mar. 8, 2007

(54) Method and apparatus for learning, recognizing and generalizing sequences

(76) Inventors: Shimon Edelman, Ithaca, NY (US); David Horn, Tel Aviv (IL); Eytan Ruppin, Reut (IL); Tsach Solan, Tel-Aviv (IL)

Correspondence Address: Martin Moynihan;Prtsi Inc, PO Box 16446, Arlington, VA, 22215, US

(21) Appl. No.: 10/566,480

(22) PCT Filed: Aug. 1, 2004
(86) PCT No.: PCT/IL04/00704

§ 371 Date: Sep. 8, 2006

(51) Int. Cl. G06F 17/30

(52) U.S. Cl. 707/6

(57) ABSTRACT

A method of generalizing a dataset having a plurality of sequences defined over a lexicon of tokens is provided. The method comprises: searching over the dataset for similarity sets, where each similarity set comprises a plurality of segments of size L having L−S common tokens and S uncommon tokens; and defining a plurality of equivalence classes corresponding to uncommon tokens of at least one similarity set. The method may further comprise a step in which a plurality of significant patterns are extracted, where each significant pattern corresponds to a most significant partial overlap between one sequence of the dataset and other sequences of the dataset. In one embodiment, a generalized dataset represented by a graph or a forest is constructed, and can be realized as a context-free grammar. The graph or forest can be used for generating sequences and/or testing grammatical structures.

### FIELD AND BACKGROUND OF THE INVENTION

The present invention relates to pattern or sequence recognition and, more particularly, to methods and apparati for learning syntax and generalizing a dataset by extracting significant patterns therefrom.

Sequence recognition methods attempt to recognize items within a dataset by matching query items to a pre-stored dictionary, having sequences of tokens representing known items. In a more general case, the dictionary contains a lexicon of tokens and set of rules instructing how to construct items from the tokens. In this case, the method recognizes a query item by verifying that its constituent tokens appear in the lexicon and its structure complies with the rules of the dictionary. Once the query item and its constituents are recognized, an appropriate output can be generated by the sequence recognition system. The output can take, for example, the form of a command to instruct a device to carry out a function, or it can be translated into a suitable format to be inputted into another application. Modern methods are also capable of constructing the dictionary using a corpus dataset onto which a training procedure is employed. Systems implementing such training procedures are often called learning systems.

Generally, there are several distinct tasks to which these learning systems are directed. One task involves the production of a particular output pattern in response to a particular input sequence. This is useful, for example, in speech recognition applications where the output might indicate a word just spoken Another task involves the generation of a complete signal when only part of the sequence is available. This is useful, for example, in the prediction of the future course of a time series given past examples. An additional task, which is somewhat a generalization of the above two tasks, is temporal association in which a specific output sequence must be produced in response to a given input sequence.

Many datasets possess structure that is hierarchical and context-sensitive. In a natural language text or a transcribed speech, for example, a corpus of language consists of a plurality of sentences, defined over a finite lexicon of tokens such as words. Alternatively, a corpus of natural language text can be regarded as a plurality of words, defined over a finite lexicon of characters. In music, a corpus of a melody can be regarded as a plurality of bars, defined over a finite lexicon of notes, or a plurality of stanzas defined over a finite lexicon of bars. Hierarchical and context-sensitive structures are also found in life-sciences, e.g., in protein datasets in which protein sequences are defined over a finite lexicon of amino acids.

The desire to make machines capable of learning and/or recognizing sequences of tokens is becoming increasingly widespread in many applications, in particular applications relating to speech, text or any other type of pattern recognition. Representative examples include: document processing, natural language processing, robotics, image processing, bioinformatics, music and the like.

Speech recognition systems, for example, can be used as add-ons in applications in which nowadays input is effected by means of a specific designated interface, such as a keyboard or a mouse. The possibility of carrying out the communication with a computer by speech input instead of keyboard or mouse unburdens the user in his work with computers and often increases the speed of input.

In the area of natural language processing, it is desired to develop systems which can analyze, understand and generate signals of naturally used languages, so as to enable humans to address machines (e.g., computers, robots) in the same way they address other humans. To function properly, these systems should recognize phrases and link phrases together in accordance with the language's syntax, and in a meaningful way.

Text recognition can be applied, for example, in communication systems in which it is inconvenient or uneconomical to use a visual display. In such systems, other means (e.g., speech synthesis means) are employed to provide information. For example, names, addresses or other information from a data processor store may be supplied to an inquiring subscriber via an electroacoustic transducer by converting text stored in a data processor into a speech message. A speech synthesizer for this purpose is adapted to recognize a stream of text and to convert it into a sequence of speech feature signals representing speech elements such as phonemes. The speech feature signal sequence is in turn applied to the electroacoustic transducer from which the desired speech message is obtained.

Pattern recognition can be employed in optical character recognition, vehicle identification, scene or image analysis, and the like. In pattern recognition systems, features of an unknown item are compared to an existing model of a predefined class. The closer the features are to the model, the higher the likelihood that the unknown item belongs to the predefined class.

In the area of bioinformatics, it is often desired to identify amino acid sequences signaling specific configurations of protein fragments from protein datasets. The information acquired from such identification is particularly useful because the biological properties of proteins are mainly affected by the proteins' three-dimensional configuration, which determines the activity of enzymes, the capacity and specificity of binding proteins such as receptors and antibodies, and the structural attributes of receptor/ligand molecules.

In traditional, statistically based, automated sequence recognition methods, a set of predetermined decision rules is used to classify sets of tokens. The tokens or relations between tokens are modeled as random variables, defining a stochastic space which is partitioned, according to the decision rules, into regions corresponding to different classes. Many such methods are based on probabilistic finite state sequence models known as hidden Markov models. A Markov chain comprises a plurality of states and a plurality of probabilities for transitions from a state to every other state or from a state to itself. The transition probabilities represent the strength of links between the elements of the Markov chain, or between the tokens constituting the sequence. Hidden Markov models are aimed at expressing the probability of a sequence in terms of the conditional probabilities of the tokens constituent in it.

In the area of generative linguistics, sequence learning and recognition methods are used for statistical grammar induction. These methods aim to identify the most probable grammar, for a given corpus [K. Lari and S. J. Young, “The estimation of stochastic context-free grammars using the Inside-Outside algorithm,” Computer Speech and Language, 4:35-56, 1990; F. Pereira and Y. Schab`es, “Inside-Outside reestimation from partially bracketed corpora,” in Annual Meeting of the ACL, 128-135, 1992].

Generally, in statistical grammar induction information can be acquired via supervised learning or unsupervised learning. In supervised leaning, global or local goal functions are used to optimize the structure of the learning system. In other words, in supervised learning there is a desired response, which is used by the system to guide the learning. Traditional supervised learning methods can be found, e.g., in D. Klein and C. D. Ming, “Natural language grammar induction using a constituent-context model,” in T. G. Dietterich, S. Becker, and Z. Ghahramani, Ed., Advances in Neural Information Processing Systems 14, Cambridge, Mass., 2002. MIT Press.

In unsupervised learning, on the other hand, there are no goal functions. In particular, the learning system is not provided with a dictionary or any morphological rules. Grammar induction methods employing unsupervised leaning can be categorized into two classes, depending whether the methods use tagged or untagged corpora in their training.

In methods in which the training includes processing of tagged corpora, the learning system learns lexical, contextual or structural constrains, which are typically extracted from manually annotated corpora Once the training stage is completed, a sequence (e.g., a sentence) of the dataset can be tagged by searching a tag sequence having a maximal significance in terms of the lexical and contextual constrains.

In methods of in which the training includes processing of untagged text (raw data), the training is devoid of any grammar- or content-related analyses. Instead, computational models are employed for generating clusters of words, and, using the clusters for calculating, e.g., transition probabilities.

To date, traditional unsupervised learning techniques are mostly performed on tagged corpora. Representative examples include: alignment-based learning [M. van Zaanen and P. Adriaans, “Comparing two unsupervised grammar induction systems: Alignment-based learning vs. EMILE,” Report 05, School of Computing, Leeds University, 2001], regular expression extraction, also known as “local grammar extraction” [M. Gross, “The construction of local grammars,” in E. Roche and Y. Schabès, Ed., Finite-State Language Processing, 329-354, MIT Press, Cambridge, Mass., 1997] and algorithms that rely on the minimum description length principle [J. G. Wolff. Learning syntax and meanings through optimization and distributional analysis,” in Y. Levy, I. M. Schlesinger and M. D. S. Braine, Ed., Categories and Processes in Language Acquisition, 179-215, Lawrence Erlbaum, Hillsdale, N.J., 1988].

Unsupervised grammar induction techniques working from raw data are in principle difficult to test. Unlike supervised techniques, which can be scored by their ability to reconstruct grammatical pattern of the input grammar, any “gold standard” that can be used to test generativity of unsupervised grammar induction techniques invariably reflects its designers' preconceptions about the language, which are often controversial among linguists themselves. Evaluation metrics such as those based on the Penn Treebank [M. P. Marcus and B. Santorini and M. A. Marcinkiewicz, “Building a Large Annotated Corpus of English: The Penn Treebank,” Computational Linguistics, 19(2):313-330, 1994], often present a skewed picture of the system's performance. In the domain of language, it is desired that the success of a learning algorithm be measured by the closeness of a learned grammar and a target grammar. However, in prior art unsupervised learning techniques the closeness between grammars is un-decidable (see, e.g., page 203 of J. E. Hopcroft and J. D. Ullman, “Introduction to Automata Theory, Languages, and Computation”, Addison-Wesley, 1979).

A key problem for any learning system in which many interacting parts determine the system's performance, is known as the credit assignment problem. Broadly speaking, credit assignment deals with the problem of quantifying the contribution of every active part of the system to the desired goal. Standard probabilistic learning methods typically strive to optimize a global criterion such as the likelihood of the entire corpus, thereby aggravating the credit assignment problem and making the entire learning procedure less reliable or, at best, less economical.

Furthermore, in all prior art methods the classification is primarily based on a variety of heuristics, hence being model-dependent. For example, in standard probabilistic learning methods, the classification is based on the predetermined decision rules, such as the aforementioned Markov transition probabilities; in supervised grammar induction, the classification is based on predetermined goal functions; and in prior art unsupervised grammar induction, the learning is biased by a priori assumptions relating to content, grammar or structure.

Another key problem for learning systems is known as the scaling problem, where for large number of tokens, sequences or rules, the system becomes computationally intensive and the learning time grows rapidly. It is recognized that conventional unsupervised learning techniques are practically unable to process large-scale raw corpora. For example, in alignment-based learning a typical corpus includes no more than about 50 rules.

There is thus a widely recognized need for, and it would be highly advantageous to have a method and apparatus for learning, recognizing and/or generalizing sequences, devoid of the above limitations.

### SUMMARY OF THE INVENTION

According to one aspect of the present invention there is provided a method of extracting significant patterns from a dataset having a plurality of sequences defined over a lexicon of tokens, the method comprising, for each sequence of the plurality of sequences: searching for partial overlaps between the sequence and other sequences of the dataset, applying a significance test on the partial overlaps, and defining a most significant partial overlap as a significant pattern of the sequence, thereby extracting significant patterns from the dataset.

According to further features in preferred embodiments of the invention described below, the search for partial overlaps is by constructing a graph having a plurality of paths representing the dataset and searching for partial overlaps between paths of the graph.

According to still further features in the described preferred embodiments the search for partial overlaps between paths of the graph comprises: defining, for each path, a set of sub-paths of variable lengths, thereby defining a plurality of sets of sub-paths; and for each set of sub-paths, comparing each sub-path of the set with sub-paths of other sets.

According to still further features in the described preferred embodiments the method further comprises grouping at least a few tokens of the significant pattern, thereby redefining the dataset.

According to another aspect of the present invention there is provided a method of generalizing a dataset having a plurality of sequences defined over a lexicon of tokens, the method comprising: searching over the dataset for similarity sets, each similarity set comprising a plurality of segments of size L having L−S common tokens and S uncommon tokens, each of the plurality of segments being a portion of a different sequence of the dataset; and defining a plurality of equivalence classes corresponding to uncommon tokens of at least one similarity set, thereby generalizing the dataset.

According to further features in preferred embodiments of the invention described below, the definition of the plurality of equivalence classes comprises, for each segment of each similarity set: extracting a significant pattern corresponding to a most significant partial overlap between the segment and other segments or combination of segments of the similarity set, thereby providing, for each similarity set, a plurality of significant patterns; and using the plurality of significant patterns for classifying tokens of the similarity set into at least one equivalence class; thereby defining the plurality of equivalence classes.

According to still further features in the described preferred embodiments the classification of the tokens comprises, selecting a leading significant pattern of the similarity set, and defining uncommon tokens of segments corresponding to the leading significant pattern as an equivalence class.

According to still further features in the described preferred embodiments the method further comprises, prior to the search for the similarity sets: extracting a plurality of significant patterns from the dataset, each significant pattern of the plurality of significant patterns corresponding to a most significant partial overlap between one sequence of the dataset and other sequences of the dataset; and for each significant pattern of the plurality of significant patterns, grouping at least a few tokens of the significant pattern, thereby redefining the dataset.

According to still further features in the described preferred embodiments the method further comprises, for each similarity set having at least one equivalence class, grouping at least a few tokens of the similarity set thereby redefining the dataset.

According to still further features in the described preferred embodiments the method further comprises for each sequence, searching over the sequence for tokens being identified as members of previously defined equivalence classes, and attributing a respective equivalence class to each identified token, thereby generalizing the sequence, thereby further generalizing the dataset.

According to still further features in the described preferred embodiments the attribution of the respective equivalence class to the identified token is subjected to a generalization test and/or a significance test.

According to still further features in the described preferred embodiments the generalization test comprises determining a number of different sequences having tokens being identified as other elements of the respective equivalence class, and if the number of different sequences is larger than a predetermined generalization threshold, then attributing the respective equivalence class to the identified token.

According to still further features in the described preferred embodiments the significance test comprises: for each sequence having elements of the respective equivalence class, searching for partial overlaps between the sequence and other sequences having elements of the respective equivalence class, and defining a most significant partial overlap as a significant pattern of the sequence, thereby extracting a plurality of significant patterns; selecting a leading significant pattern of the plurality of significant patterns; and if the leading significant pattern includes the identified token, then attributing the respective equivalence class to the identified token.

According to yet another aspect of the present invention there is provided a method of extracting significant patterns from a dataset having a plurality of sequences defined over a lexicon of tokens, the method comprising: (a) constructing a graph having a plurality of vertices and paths of vertices, each vertex representing one token of the lexicon, such that each sequence of the plurality of sequences is represented by one path of the plurality of paths; and (b) for each path of the plurality of paths: searching for partial overlaps between the path and other paths, applying a significance test on the partial overlaps, and defining a most significant partial overlap as a significant pattern of the path; thereby extracting significant patterns from the dataset.

According to further features in preferred embodiments of the invention described below, the search for partial overlaps between paths of the graph comprises defining a set of sub-paths of variable lengths for the path, and comparing each sub-path of the path with sub-paths of other paths.

According to still further features in the described preferred embodiments the application of the significance test is by evaluating a statistical significance of the set of probability functions.

According to still further features in the described preferred embodiments the set of probability functions constitutes a variable-order Markov matrix.

According to still further features in the described preferred embodiments the evaluation of the statistical significance is by using elements of the variable-order Markov matrix to calculate a set of cohesion coefficients for each path, and selecting a supremum of the set of cohesion coefficients.

According to still further features in the described preferred embodiments the set of probability functions comprises for each sub-path of the path, a probability function characterizing a rightward direction on the sub-path, and a probability function characterizing a leftward direction on the sub-path.

According to still further features in the described preferred embodiments the method further comprises for each significant pattern, defining a pattern-vertex representing at least a few vertices of the significant pattern, thereby redefining the graph.

According to still another aspect of the present invention there is provided a method of generalizing a dataset having a plurality of sequences defined over a lexicon of tokens, the method comprising: (a) constructing a graph having a plurality of vertices and paths of vertices, each vertex representing one token of the lexicon, such that each sequence of the plurality of sequences is represented by one path of the plurality of paths; (b) searching over the plurality of paths for similarity sets, each similarity set comprising a plurality of paths sharing L−S vertices within an L-size window, hence defining S slots each being a set of different vertices; and (c) defining a plurality of equivalence classes corresponding to at least one slot of at least one similarity set; thereby generalizing the dataset.

According to further features in preferred embodiments of the invention described below, the method further comprises repeating steps (b) and step (c), a plurality of times while permuting a searching order of step (b), thereby providing a plurality of generalized datasets, each characterized by a generalization factor, and selecting a generalized dataset corresponding to a maximal generalization factor.

According to still further features in the described preferred embodiments the generalization factor is defined as a ratio between a number of sequences of the generalized dataset and a number of sequences of the dataset.

According to still further features in the described preferred embodiments each generalized dataset is characterized by a precision value and a recall value, and the method further comprises selecting a generalized dataset which corresponds to an optimal combination of the precision value and the recall value.

According to an additional aspect of the present invention there is provided a method of executing at least one action based on at least one instruction, the method comprising, inputting a dataset having a plurality of sequences defined over a lexicon of tokens, learning the dataset so as to provide a generalized dataset, inputting an instruction, using the generalized dataset for determining an action corresponding to the instruction, and executing the action; wherein the learning the dataset comprises: (a) constructing a graph having a plurality of vertices and paths of vertices, each vertex representing one token of the lexicon, such that each sequence of the plurality of sequences is represented by one path of the plurality of paths; (b) searching over the plurality of paths for similarity sets, each similarity set comprising a plurality of paths sharing L−S vertices within an L-size window, hence defining S slots each being a set of different vertices; and (c) defining a plurality of equivalence classes corresponding to at least one slot of at least one similarity set, thereby providing a generalized dataset.

According to further features in preferred embodiments of the invention described below, the input of the instruction, the use of the generalized dataset for determining the action, and the execution of the action is repeated at least once.

According to still further features in the described preferred embodiments the instruction is a written instruction.

According to still further features in the described preferred embodiments the instruction is a verbal instruction.

According to still further features in the described preferred embodiments the definition of the plurality of equivalence classes comprises, for each segment of each similarity set: for each path of each similarity set, extracting a significant pattern corresponding to a most significant partial overlap between the path and other paths or combinations of paths of the similarity set, thereby providing, for each similarity set, a plurality of significant patterns; and using the plurality of significant patterns for classifying vertices of the similarity set into at least one equivalence class; thereby defining the plurality of equivalence classes.

According to still further features in the described preferred embodiments the classification of vertices comprises selecting a leading significant pattern of the similarity set, and defining a slot corresponding to the leading significant pattern as an equivalence class.

According to still further features in the described preferred embodiments the method further comprises redefining the graph prior to step (b) as follows: for each path of the plurality of paths, extracting a significant pattern corresponding to a partial overlap between the path and paths other then the path, thereby providing a plurality of significant patterns; and for each significant pattern of the plurality of significant patterns, defining a pattern-vertex representing at least a few vertices of the significant pattern.

According to still further features in the described preferred embodiments the method further comprises, subsequently to step (c), defining, for each similarity set having at least one equivalence class, a generalized-vertex representing all vertices of a respective L-size window of the similarity set, thereby redefining the graph.

According to still further features in the described preferred embodiments the method further comprises repeating step (b) and step (c), subsequently to the redefinition of the graph, at least once.

According to still further features in the described preferred embodiments the method further comprises for each path, searching over the path for vertices being identified as members of previously defined equivalence classes, and attributing a respective equivalence class to each identified vertex, thereby generalizing the path, thereby further generalizing the dataset.

According to still further features in the described preferred embodiments the attribution of the respective equivalence class to the identified vertex is subjected to a generalization test.

According to still further features in the described preferred embodiments the generalization test comprises determining a number of different paths having, within the L-size window, vertices being identified as other elements of the respective equivalence class, and if the number of different paths is larger than a predetermined generalization threshold, then attributing the respective equivalence class to the identified vertex.

According to still further features in the described preferred embodiments the attribution of the respective equivalence class to the identified vertex is subjected to a significance test.

According to still further features in the described preferred embodiments the significance test comprises: for each path having elements of the respective equivalence class, searching for partial overlaps between the path and other paths having elements of the respective equivalence class, and defining a most significant partial overlap as a significant pattern of the path, thereby extracting a plurality of significant patterns; selecting a leading significant pattern of the plurality of significant patterns; and if the leading significant pattern includes the identified vertex, then attributing the respective equivalence class to the identified vertex.

According to still further features in the described preferred embodiments the method further comprises marking endpoints of each path of the plurality of paths, by adding a first marking vertex before a first vertex of the path and a second marking vertex after a last vertex of the path.

According to still further features in the described preferred embodiments the method further comprises calculating, for each path, a set of probability functions characterizing the partial overlaps.

According to still further features in the described preferred embodiments the extraction of the significant pattern from the path is by a evaluating a statistical significance of the set of probability functions.

According to yet an additional aspect of the present invention there is provided an apparatus for extracting significant patterns from a dataset having a plurality of sequences defined over a lexicon of tokens, the apparatus comprising: (a) a searcher, for searching for partial overlaps between the sequence and other sequences of the dataset; (b) a testing unit, for applying a significance test on the partial overlaps; and (c) a definition unit, for defining a most significant partial overlap as a significant pattern of the sequence.

According to further features in preferred embodiments of the invention described below, the searcher is designed to search for partial overlaps between paths of the graph.

According to still further features in the described preferred embodiments the searcher comprises: a sub-path definer, for -defining a plurality of sets of sub-paths, one sets of sub-path for each path; and a sub-path comparer, for comparing for a given set of sub-paths, each sub-path of the set with sub-paths of other sets.

According to still further features in the described preferred embodiments the testing unit is capable of evaluating a statistical significance of the set of probability functions.

According to still an additional aspect of the present invention there is provided an apparatus for generalizing a dataset having a plurality of sequences defined over a lexicon of tokens, the apparatus comprising: (a) a searcher, for searching over the dataset for similarity sets, each similarity set comprising a plurality of segments of size L having L−S common tokens and S uncommon tokens, each of the plurality of segments being a portion of a different sequence of the dataset; and (b) a definition unit, for defining a plurality of equivalence classes corresponding to uncommon tokens of at least one similarity set, thereby generalizing the dataset.

According to further features in preferred embodiments of the invention described below, the apparatus further comprises an extractor, capable of extracting, for a given set of sequences, a significant pattern corresponding to a most significant partial overlap between one sequence of the set of sequences and other sequences of the set of sequences, thereby providing, for the given set of sequences, a plurality of significant patterns.

According to still further features in the described preferred embodiments the given set of sequences is a similarity set, hence the plurality of significant patterns corresponds to the similarity set.

According to still further features in the described preferred embodiments the definition unit comprises a classifier, capable of classifying tokens of the similarity set into at least one equivalence class using the plurality of significant patterns.

According to still further features in the described preferred embodiments the classifier is designed for selecting a leading significant pattern of the similarity set, and defining uncommon tokens of segments corresponding to the leading significant pattern as an equivalence class.

According to still further features in the described preferred embodiments the given set of sequences is the dataset, hence the plurality of significant patterns corresponds to the dataset.

According to still further features in the described preferred embodiments the apparatus further comprises a first grouper for grouping at least a few tokens of each significant pattern of the plurality of significant patterns.

According to still further features in the described preferred embodiments the apparatus further comprises a second grouper, for grouping at least a few tokens of each similarity set having at least one equivalence class.

According to still further features in the described preferred embodiments the apparatus further comprises a second definition unit having a second searcher, for searching over each sequence for tokens being identified as members of previously defined equivalence classes, wherein the second definition unit is designed to attribute a respective equivalence class to each identified token.

According to still further features in the described preferred embodiments the apparatus further comprises a constructor, for constructing a graph having a plurality of paths representing the dataset.

According to still further features in the described preferred embodiments the extractor is designed to search for partial overlaps between paths of the graph.

According to still further features in the described preferred embodiments the graph comprises a plurality of vertices, each representing one token of the lexicon, and further wherein each path of the plurality of paths comprises a sequence of vertices respectively corresponding to one sequence of the dataset.

According to still further features in the described preferred embodiments the apparatus further comprises electronic-calculation functionality for calculating, for each path, a set of probability functions characterizing the partial overlaps.

According to still further features in the described preferred embodiments the extractor comprises a testing unit capable of evaluating a statistical significance of the set of probability functions.

According to still further features in the described preferred embodiments the dataset comprises a corpus of text.

According to still further features in the described preferred embodiments the dataset comprises a protein database.

According to still further features in the described preferred embodiments the dataset comprises a DNA database.

According to still further features in the described preferred embodiments the dataset comprises an RNA database.

According to still further features in the described preferred embodiments the dataset comprises a recorded speech.

According to still further features in the described preferred embodiments the dataset comprises a corpus of music notes.

According to still further features in the described preferred embodiments the dataset comprises a weblog database.

According to still further features in the described preferred embodiments the dataset comprises trajectory records of a transportation network. According to still further features in the described preferred embodiments the dataset comprises activity records of a self-active system.

According to still further features in the described preferred embodiments the dataset comprises records of operational steps in a technical process.

According to a further aspect of the present invention there is provided a generalized dataset produced by any of the methods or apparati described above, the generalized dataset is stored, in a retrievable and/or displayable format, on a memory medium.

According to yet a further aspect of the present invention there is provided a memory medium, storing the generalized dataset in a retrievable and/or displayable format.

According to still a further aspect of the present invention there is provided a generalized dataset defined over a lexicon of tokens and stored in a retrievable and/or displayable format on a memory medium, the generalized dataset being represented by a forest hierarchy having a plurality of multilevel trees, each tree of the plurality of multilevel trees representing a pattern of tokens of the generalized dataset and comprising a leaf level, having a plurality of child nodes, and at least one partition level, having at least one parent node, wherein each child node of the leaf level corresponds to a token, and each parent node of the at least one partition level corresponds to a significant patterns of tokens or an equivalence class of tokens.

According to still a further aspect of the present invention there is provided a memory medium, storing in a retrievable and/or displayable format, a generalized dataset defined over a lexicon of tokens and represented by a forest hierarchy having a plurality of multilevel trees, each tree of the plurality of multilevel trees representing a pattern of tokens of the generalized dataset and comprising a leaf level, having a plurality of child nodes, and at least one partition level, having at least one parent node, wherein each child node of the leaf level corresponds to a token, and each parent node of the at least one partition level corresponds to a significant patterns of tokens or an equivalence class of tokens.

According to still a further aspect of the present invention there is provided a generalized dataset defined over a lexicon of tokens and stored in a retrievable and/or displayable format on a memory medium, the generalized dataset being represented by a graph having a plurality of vertices selected from the group consisting of token-vertices, pattern-vertices and generalized-vertices, wherein each token-vertex represents a token of the lexicon, each pattern-vertex represents a significant pattern of tokens, and each generalized-vertex represents an equivalence class of tokens.

According to still a further aspect of the present invention there is provided a memory medium, storing in a retrievable and/or displayable format, a generalized dataset defined over a lexicon of tokens and represented by a graph having a plurality of vertices selected from the group consisting of token-vertices, pattern-vertices and generalized-vertices, wherein each token-vertex represents a token of the lexicon, each pattern-vertex represents a significant pattern of tokens, and each generalized-vertex represents an equivalence class of tokens.

The present invention successfully addresses the shortcomings of the presently known configurations by providing a method and apparatus for learning, recognizing and/or generalizing sequences, far exceeding prior art methods. Additionally the present invention successfully provides a generalized dataset of sequences.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart diagram of a method of extracting significant patterns from a dataset, according to a preferred embodiment of the present invention;

FIGS. 2a-b are simplified illustrations a structured graph (FIG. 2a) and a random graph (FIG. 2b), according to a preferred embodiment of the present invention;

FIG. 3 illustrates a representative example of a portion of a graph with a search-path going through five vertices, according to a preferred embodiment of the present invention;

FIG. 4 illustrates a pattern-vertex having three vertices which are identified as significant pattern of the trial path of FIG. 3, according to a preferred embodiment of the present invention;

FIG. 5 is a flowchart diagram of a method of generalizing the dataset, according to a preferred embodiment of the present invention;

FIG. 6a is a schematic illustration of a portion of a graph constructed for a corpus of text in which the tokens are words and the sequences are sentences, according to a preferred embodiment of the present invention;

FIG. 6b illustrates a generalized-vertex, defined for a similarity set having an equivalence class, according to a preferred embodiment of the present invention;

FIG. 7a illustrates a portion of a graph in which an equivalence class is attributed to vertices identified as elements thereof, according to a preferred embodiment of the present invention;

FIG. 7b illustrates an additional step of the method in which once a particular path has been supplemented by an additional equivalence class, the graph or a portion thereof is rewired, by defining a generalized-vertex including the existing equivalence class and the newly attributed equivalence class, according to a preferred embodiment of the present invention;

FIG. 7c illustrates the additional step of FIG. 7b, with an optional modification in which the generalized-vertex also includes other vertices within a predetermined window, according to a preferred embodiment of the present invention;

FIG. 8 is a simplified illustration of an apparatus for extracting significant patterns from a dataset, according to a preferred embodiment of the present invention;

FIG. 9 a simplified illustration of an apparatus 90 for generalizing a dataset, according to a preferred embodiment of the present invention;

FIG. 10 is a flowchart diagram of a method of executing at least one action based on at least one instruction, according to a preferred embodiment of the present invention;

FIGS. 11a-c illustrate nested relationships between significant patterns and equivalence classless in a tree format, according to a preferred embodiment of the present invention;

FIGS. 11d-e illustrate nested relationships between significant patterns and equivalence classless in a tree format, according to a preferred embodiment of the present invention;

FIG. 12 shows precision and recall values attained by 30 trials of an experiment involving a context free grammar with 53 words and 40 rules, performed according to a preferred embodiment of the present invention;

FIG. 13 shows results of random pairwise interchanges of words in the various sentences, performed on the corpus generated by a “teacher” machine, according to a preferred embodiment of the present invention;

FIGS. 14a-b show precision and recall of multiple learners training for a context free grammar, according to a preferred embodiment of the present invention;

FIG. 15a shows assessments often humans for a natural language dataset and a generalized dataset obtained therefrom according to a preferred embodiment of the present invention;

FIG. 15b shows a portion of a forest representation of a generalized dataset obtained from the child-directed speech;

FIG. 16a is a histogram showing the proportions of patterns defined in terms of three categories: patterns, equivalence classes and terminals, according to a preferred embodiment of the present invention;

FIG. 16b is a dendrogram representation of the histogram of FIG. 16a;

FIGS. 17a-b show compression degree for three open reading frames of a C. Elegans genes dataset, as a function of the number of iterations, for the first exon (FIG. 17a) and 500 bases (FIG. 17b), according to a preferred embodiment of the present invention; and

FIG. 18 shows functional protein classification of 15 Enzyme Commission classes, level 2.

### DESCRIPTION OF THE PREFERRED EMBODIMENTS

The present invention is of methods and apparati for extracting significant patterns which can be used for learning syntax and generalizing a dataset. Specifically, the present invention can be used to learn syntax and generalize a corpus of text, a protein database, a DNA database, an RNA database, a recorded speech, a corpus of music notes, a database of World Wide Web logs (also known as ClickSteams) and the like. The present invention is further of a generalized dataset produced, e.g., by the methods or apparati of the present invention.

The present invention can thus be used in numerous fields in which it is desired to extract useful information from datasets. Representative examples include, without limitation, grammar induction, data mining, information retrieval, semantic network, bioinformatics, transportation, robotics and communication. In grammar induction, the present invention can be used, for example, to construct a generalized dataset representing a grammatical structure, such as, but not limited to, a context free grammar; in data mining, the present invention can be used, for example, as an aid to determine purchasing habits, thereby to facilitate better planing of, e.g., store displays or inventory; in information retrieval, the present invention can be used, for example, to classify documents or other searched items according to their sequential structure; in semantic network, the present invention can be used, for example, to extract semantic relations between items or concepts, thereby to determine meaningful inter-relational structure of the network or a domain thereof; in bioinformatics, the present invention can be used, for example, to reveal hierarchical structure in DNA sequences or functionally relevant motifs in protein data; in the field of transportation, the present invention can be used, for example, to recognize roadway seasonal traffic patterns, hence to predict loads of transport routes; in robotics, the present invention can be used, for example, to identify motions of a robot; in communication, the present invention can be used, for example, to aid the planning of an efficient communication network by identifying frequently used communication trajectories.

The principles and operation of significant patterns extraction and datasets generalization according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As stated in the Background section above, prior art syntax learning approaches attempt to acquire linguistic knowledge, by imposing a priori assumptions on the dataset on which they operate. In a search for unsupervised learning which is unbiased by a priori assumptions relating to content, grammar or structure of the dataset, the present inventors have found that significant patterns can be extracted from a dataset by searching for structural similarities hence acquiring inherent statistical information from the dataset.

Thus, according to one aspect of the present invention there is provided a method of extracting significant patterns from a dataset, generally referred to as method 10. Method 10 can be applied on any dataset having a plurality of sequences defined over a lexicon of tokens.

For example, in one embodiment, the dataset is a corpus of text in which the sequences are sentences and the lexicon of tokens is a lexicon of words. In another embodiment, the dataset can be a corpus of text in which the sequences are words, and the lexicon of tokens is a lexicon of characters.

In an additional embodiment, the dataset can be a corpus of text of an agglutinative language, such as, but not limited to, an Asian language (e.g., Chinese, Japanese, Hangul), written using special characters (“ideographs”) each representing one or more syllables and typically a concept or meaningful unit. For such text corpora, the lexicon of tokens is preferably a lexicon of ideographs and the sequences may include one or more ideographs.

In still another embodiment, the dataset can also be in a form of a recorded speech, in which case the tokens can be spoken syllables which are sequenced to spoken words or phrases.

In a further embodiment, the dataset can be a protein database with a lexicon of 20 amino acids, or a DNA dataset with a lexicon of amino acids or DNA base pairs.

In still a further embodiment, generally related to the area of data mining, the dataset can be customer transaction database from which the method can be used to extract customer purchasing patterns, to thereby learn about purchasing habits.

Also contemplated are: (i) a music dataset in which the sequences can be bars or stanzas and the tokens can be music notes or bars; (ii) a dataset with trajectory records of a transportation network, in which the sequences can be the trajectories and the tokens can be geographical locations such as stations or intersections between different trajectories; (iii) a dataset with activity records of a self-active system, such as a robot, in which case the tokens can represent different activities (motion types, motion directions, operations, etc.), such that different sequences represent different tasks or different alternatives for the self-active system to perform a particular task; and (iv) a dataset with records of operational steps in a technical process, such as a micro-fabrication process, in which case the tokens can represent different steps of the process such that different sequences represent, e.g., different sub-process.

It is expected that during the life of this patent many relevant sequential datasets will be developed and the scope of the terms “token” and “sequence of tokens” are intended to include all such new technologies a priori. Additionally, it is to be understood that although the dataset is generally referred to herein as discrete, continuous datasets are not excluded. Specifically, a continuous dataset can be discretised prior to the implementation of any operation which, according to a preferred embodiment of the present invention requires a discrete input.

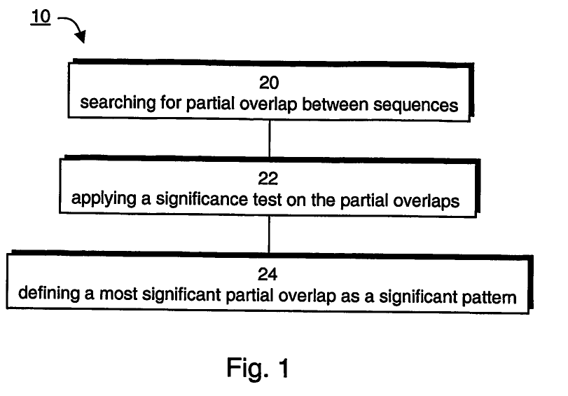

Referring now to the drawings, method 10 comprises the following method steps which are illustrated in the flowchart of FIG. 1. Hence, in a first step, designated by Block 20, overlaps between sequences of the dataset are searched, considering each sequence of the dataset as “trial-sequence” which is compared, segment by segment, to all other sequences.

This can be done for example, by constructing a graph which represents the dataset. Such graph may include a plurality of vertices and paths of vertices, where each vertex represent one token of the lexicon and each path of vertices represent a sequence of the dataset. Thus, according to a preferred embodiment of the present invention, for a lexicon of size N (say, N different words), there are N vertices on the graph. These N vertices are connected thereamongst by edges, preferably directed edges, in many combinations, depending on the sequences of the raw dataset on which the method of the presently preferred embodiment is applied.

The endpoints of each path of the graph are preferably marked, e.g., by adding marking vertices, such as a “begin” vertex before its first vertex and an “end” vertex after its last vertex. These marking vertices represent the beginning and end of the respective sequence of the dataset. For example, when the sequences are sentences of a text corpus, the “begin” and “end” vertices can be interpreted as regular expression tokens which are typically used by text editors to locate the endpoints of a sentence. Thus, each vertex which represents a token has at least one incoming path and at least one outgoing path, preferably an equal number of incoming and outgoing paths.

Once the graph is constructed, overlaps between the paths thereof can be searched, for example, by considering different sub-paths of different lengths for each path and comparing these sub-paths with sub-paths of other paths of the graph. As the dataset inherently possesses some kind of structure, the constructed graph is not a random graph. Rather, the graph represents the structure of the dataset with the appearance of bundles of sub-paths, signifying a relatively high probability associated with a given sub-structure which can be identified as a motif.

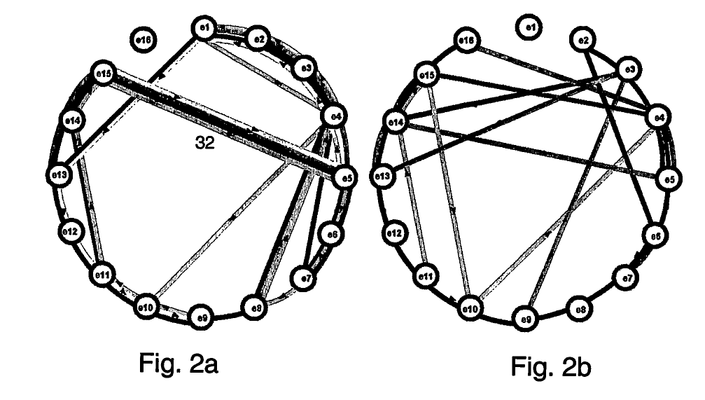

FIGS. 2a-b, show simplified illustrations a structured graph (FIG. 2a) and a random graph (FIG. 2b). Shown in FIGS. 2a-b, a plurality of vertices e1, e2, . . . , e16, each representing one token of the lexicon. Referring to FIG. 2a, of particular interest are vertex e1 and vertex e15 which are connected by many sub-paths of the graph, hence defining an overlap 32 therebetween.

In a second step of method 10, designated in FIG. 1 by Block 22, a significance test is applied on the partial overlaps which are obtained in the first step of method 10. Significance tests are known in the art and can include, for example, statistical evaluation of flow quantities, such as, but not limited to, probability functions or conditional probability functions which characterize the partial overlaps between paths on the graph.

According to a preferred embodiment of the present invention a set of probability functions is defined using the number of paths connecting particular vertices on the graph. For example, considering a single vertex, e₁, on the graph, a probability, p(e₁), can be defined as the number of paths leaving e₁ divided by the total number of paths. Similarly, considering two vertices, e₁ and e₂, a (conditional) probability, p(e₂|e₁), can be defined as the number of paths leading from e₁ to e₂ divided by the total number of paths leaving e₁. This prescription is preferably applied to all combinations of vertices on the graph, defining, e.g., p(e₁), p(e₂|e₁), p(e₃|e₁e₂), for paths leaving e₁ and going through e₂ and e₃, and p(e₁), p(e₁|e₂), p(e₁|e₂e₃), for paths going through e₃ and e₂ and entering e₁.

In terms of all the conditional probabilities, the graph can define a Markov model. Thus, a “search-path,” of length K, going through vertices e₁ e₂ . . . e_{K} on the graph (corresponding to a trial-sequence of K tokens of the dataset), can be used to define a variable order Markov model up to order K, represented by the following matrix:

$$M = ( \begin{matrix}p ( {e}_{1} ) & p ( {e}_{1} \vert {e}_{2} ) & p ( {e}_{1} \vert {e}_{2} {e}_{3} ) & ⋯ & p ( {e}_{1} \vert {e}_{2} ⋯ {e}_{K} ) \\ p ( {e}_{2} \vert {e}_{1} ) & p ( {e}_{2} ) & p ( {e}_{2} \vert {e}_{1} ) & ⋯ & p ( {e}_{2} \vert {e}_{3} ⋯ {e}_{K} ) \\ p ( {e}_{3} \vert {e}_{1} {e}_{2} ) & p ( {e}_{3} \vert {e}_{2} ) & p ( {e}_{3} ) & ⋯ & p ( {e}_{3} \vert {e}_{4} ⋯ {e}_{K} ) \\ ⋮ & & & ⋰ & ⋮ \\ p ( {e}_{K} \vert {e}_{1} {e}_{2} ⋯ {e}_{K - 1} ) & p ( {e}_{K} \vert {e}_{2} ⋯ {e}_{K - 1} ) & p ( {e}_{K} \vert {e}_{3} ⋯ {e}_{K - 1} ) & ⋯ & p ( {e}_{K} )\end{matrix} ) \qquad ( EQ . 1 )$$

For any sub-path of e1e2 . . . eK having a length m<K, a similar Markov model can be obtained from an m×m diagonal sub-matrix of M. It will be appreciated that whereas the collection of all paths which represent a sequence of the dataset defines all the conditional probabilities appearing in M, the search-path e1e2 . . . eK used in M does not necessarily represent a sequence of the dataset. The definition of the search-path is based on conditional probabilities, such as p(e₂|e₁), which are predeternined by those paths which represent the sequences of the dataset.

An occurrence of a significant overlap (e.g., overlap 32 in FIG. 2a), along a search-path can be identified by observing some extreme values of the relevant conditional probabilities. According to a preferred embodiment of the present invention, the probability functions comprise probability functions characterizing a rightward direction on each path and probability function characterizing a leftward direction on each path. Thus, for a search-path e₁e₂ . . . , eₘ, . . . eₖ, a probability function, P_{R}, characterizing a rightward direction, is preferably defined by the first column of M, moving top down, and a probability function, P_{L}, characterizing a leftward direction, is preferably defined by the last column of M, moving bottom up. Specifically,
P_{R}(n)=p(eₙ|e₁e₂ . . . eₙ₋₁) and P_{L}(n)=p(eₙ|eₙ₊₁eₙ₊₂ . . . eₖ). (EQ. 2)

As will be appreciated by one ordinarily skilled in the art, both P_{R} and P_{L} vary between 0 and 1 and are specific to the path in question.

In terms of the number of paths, P_{R} and P_{L} can be understood considering, for simplicity, that the path in question is e1e2e3e4 (K=4). Hence, according to a preferred embodiment of the present invention, P_{R}(3)=p(e3|e1 e2), the rightward direction probability corresponding to the sub-path e1e2e3 equals the number of paths moving from e1 through e2 into e3 divided by the number of paths moving from e1 to e2, and P_{L}(3)=p(e3|e4), the leftward direction probability corresponding to the sub-path e3e4 equals the number of paths moving from e3 to e4 divided by the number of paths entering e4. It is convenient to define the aforementioned probabilities in the explicit notations P_{R}(e1;e3) and P_{L}(e4;e3), respectively.

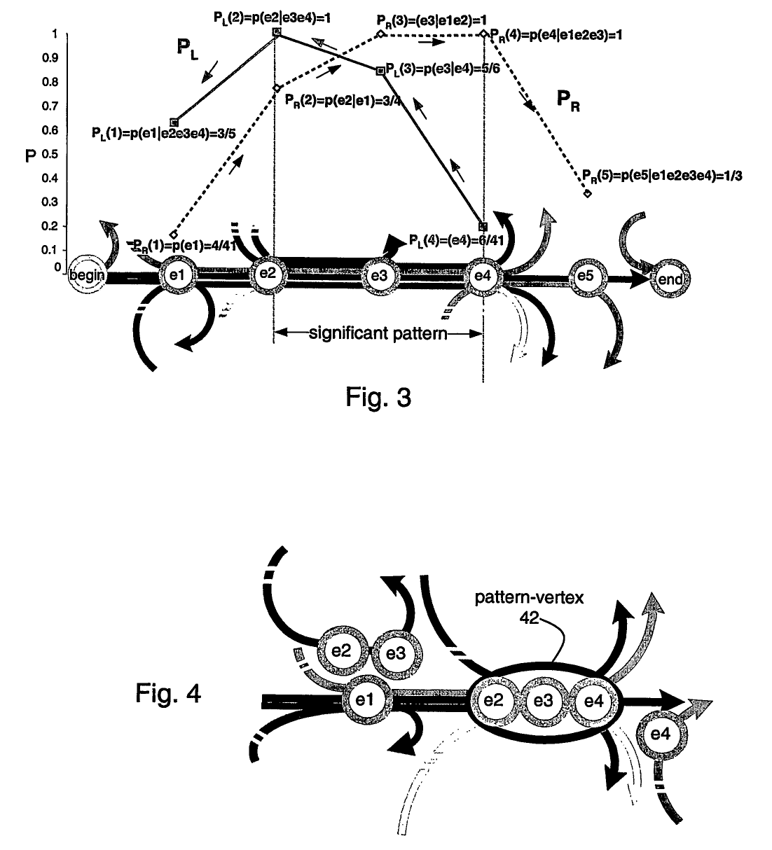

FIG. 3 illustrate a representative example of a portion of a graph in which a search-path, going through e1e2e3e4e5 and marked with a “begin” vertex at its beginning and an “end” vertex on its end, is selected. Also shown in FIG. 3, are other paths, joining and leaving the search-path at various vertices. The bundle of sub-paths between vertex e2 and vertex e4 displays certain coherence, possibly indicating the presence of a significant pattern in the dataset.

To illustrate the use of the probabilities P_{R} and P_{L}, the portion of the graph is positioned in a rectangle coordinate system in which the vertices are conveniently arranged along the abscissa while the ordinate represent probability values. Progressing from e1 rightwards, P_{R}(n), n=1, 2, 3, 4, 5, has the values 4/41, ¾, 1, 1 and ⅓ respectively. Progressing from e4 leftwards, P_{L}(n), n=4, 3, 2, 1 has the values 6/41, ⅚, 1 and ⅗.

Thus, P_{R} first increases because some other paths join to form a coherent bundle, then decreases at e5, because many paths leave the path at e4. Similarly, progressing leftward, P_{L} first increases because other paths join as e4 and then decreases because paths leave the path at e2. The decline of P_{R} or P_{L} is preferably interpreted as an indication of the end of the candidate pattern. The overlaps can be identified by requiring that the values of P_{R} and P_{L} within a candidate overlap are sufficiently large. Thus, a candidate overlap can be defined as a sub-sequence represented by a path or a sub-path on the graph in which P_{R}>1−ε_{R} and P_{L}>1ε_{L} where ε_{R} and ε_{L} are two parameters smaller than unity. A typical value for ε_{R} and ε_{R} is from about 0.01 to about 0.99.

As used herein the term “about” refers to ±10%.

Optionally and preferably, the decrement of P_{R} and P_{L} can be quantified by defining decrease functions and comparing their values with predetermined cutoffs hence to identify overlaps between paths or sub-paths. According to a preferred embodiment of the present invention, the decrease functions are defined as ratios between probabilities of paths having some common vertices. In the example shown in FIG. 3 the decrement of P_{R} at e4 can be quantified using a rightward direction decrease function, D_{R}, defined as D_{R}(e1;e4)=P_{R}(e1;e5)/P_{R}(e1;e4), and the decrement of P_{L} at e2 can be quantified using a leftward direction decrease function, D_{L}, defined as D_{L}(e4;e2)=P_{L}(e4;e1)/P_{L}(e4;e2). Denoting the predetermined cutoffs by η_{R} and η_{L}, respectively, a partial overlap can be identified when both D_{R}<η_{R} and D_{L}<η_{L}. A typical value for both η_{R} and η_{L} is from about 0.4 to about 0.8.

Thus, the statistical significance of the decreases in P_{R} and P_{L} can be evaluated, for example, by defining their significance in terms a null hypothesis and requiring that the corresponding p-values are, on the average, smaller than a predetermined threshold, α. A typical value for a is from 0.001 to 0.1.

The null hypothesis depends on the choice of the functions which characterize the overlaps. For example, when the ratios are used, the null hypothesis can be P_{R}(e1;e5)≧η_{R}P_{R}(e1;e4) and P_{L}(e4;e1)≧η_{L}P_{L}(e4;e2). Alternatively, the null hypothesis can be P_{R}>1−ε_{R} and P_{L}>1−ε_{L} or any other combination of the above conditions.

For a given search-path, P_{L} and P_{R} are preferably calculated from many starting points (such as e1 and e4 in the present example), more preferably from all starting points on the search-path, traversing each sub-path both leftward and rightward. This procedure defines many search-sections on the search-path, from which several partial overlaps can be identified. Once the partial overlaps have been identified, the most significant partial overlap is defined as a significant pattern. This step of method 10 is designated in FIG. 1 by Block 24.

In an alternative, yet preferred, embodiment, a set of cohesion coefficients, cᵢⱼ, i>j, are calculated, for each trial path, as follows:
cᵢⱼ=Mᵢⱼ log Mᵢⱼ/(Mᵢ₋₁ⱼMᵢⱼ₊₁) (EQ. 3)
where Mᵢⱼ are elements of the variable order Markov model matrix (see Equation 1). For a given search-path there are many sub-paths, each represented by an element in the set cᵢⱼ, which can be considered as an “overlap score.” Once the set cᵢⱼ is calculated, its supremum is selected and the sub-path which corresponds to the supremum is preferably defined as the significant pattern of the search-path.

It is to be understood that it is not intended to limit the scope of the present invention to the above statistical significance tests, and that other significance tests as well as other probability functions or cohesion coefficients can be implemented.

The procedure in which overlaps are searched along a search-path is preferably repeated for more than one path of the original graph, more preferably on all the paths of the original path (hence on all the sequences of the dataset). It will be appreciated that significant patterns can be found, depending on the degree by which the search-path overlaps with other paths.

According to a preferred embodiment of the present invention, the graph is “rewired” by merging each, or at least a few, significant patterns into a new vertex, referred to hereinafter as a pattern-vertex. This is equivalent to a redefinition of the dataset whereby several tokens are grouped according to the significant patterns to which they belong. This rewiring process reduces the length of the paths of the graph, nonetheless the contents of the paths in terms of the original sequences of the dataset is conserved.

In principle, the identification of the significant patterns can depend on other vertices of the search-path, and not only on the vertices belonging to the overlapping sub-paths. The extent of this dependence is dictated by the selected identification procedure (e.g., the choice of the probability functions, the significant test, etc.). Referring to the example of FIG. 3, a sub-path e2e3e4 is defined as a significant pattern of the search-path “begin”→e1→ . . . →e5→“end.” By definition, the vertices e2, e3 and e4, also belong to other paths on the graph, each in turn can also be selected as a search-path along which partial overlaps are searched. Being dependent on other vertices of the search-path, the sub-path e2e3e4 may be accepted as a significant pattern for one search-path and may be rejected, on account of failing to pass the selected significance test, for another search-path.

The definition of the pattern-vertices of the graph can therefore be done in more than one way.

In one embodiment, referred to hereinafter as the “context-sensitive embodiment,” significant patterns are merged only on the path for which they turned out to be significant, while leaving the vertices unmerged on other paths.

In another embodiment, referred to hereinafter as the “context-free embodiment,” after each search on each search-path, sub-paths which are identified as significant patterns are merged into pattern-vertex, irrespectively whether or not these sub-paths are defined as significant patterns also in other paths.

In still another embodiment, referred to hereinafter as the “single rewiring embodiment,” after each search on each search-path, the sub-paths which are identified as significant patterns are merged into a pattern-vertex.

In yet another embodiment, referred to hereinafter as the “multiple rewiring embodiment,” after each search on each search-path, the sub-paths which are identified as significant patterns are merged into pattern-vertices.

In a further embodiment, referred to hereinafter as the “batch rewiring embodiment,” after all paths are searched, the sub-paths which are identified as significant patterns are merged into pattern-vertices.

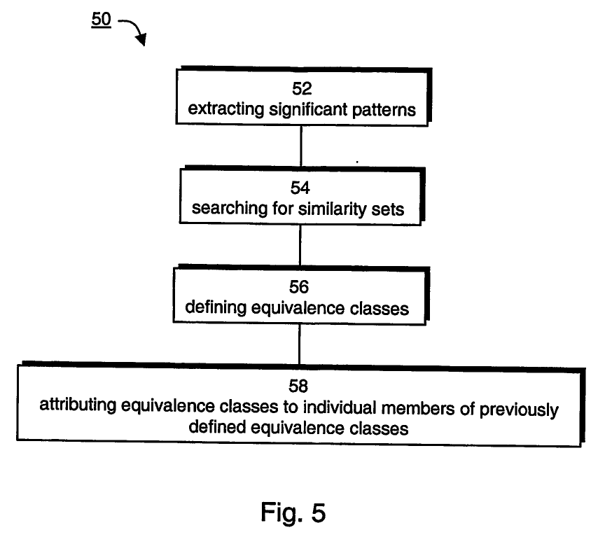

FIG. 4 illustrate a pattern-vertex 42 having vertices e2, e3 and e4, which are identified as significant pattern for the trial path of FIG. 3. Note that vertices e2, e3 and e4 remain on the graph in addition to pattern-vertex 42, because, in the present example, there is a path which goes through e2 and e3 but not through e4, and a path which goes through e4 and e5 (see FIG. 3) but not through e2 and e3.

As further detailed hereinbelow, the rewiring procedure can be used as a supplementary procedure when it is desired to provide a generalized dataset having more sequences than the original dataset. For example, when the dataset is a corpus of text in which the tokens are words and the sequences are sentences, a generalized dataset can be used for generating or recognizing sentences even when such sentences are not present in the original corpus.

Generalization of the dataset is preferably achieved by defining equivalence classes of tokens and allowing, for a given sequence, the replacement of one or more tokens of the sequence with other tokens which are members of the same equivalence class (see, e.g., J. G. Wolff, “Learning syntax and meanings through optimization and distributional analysis,” in Y. Levy, I. M. Schlesinger and M. D. S. Braine, Ed., Categories and Processes in Language Acquisition, 179-215, Lawrence Erlbaum, Hillsdale, N.J., 1988).

For example, suppose that for a particular dataset an equivalence class, E, of two vertices, e3 and e6, is defined, i.e., E={e3, e6}. Suppose further that among the sequences of the dataset there are two sequences, say, e1e2e3e4e5 and e1e2e6e4e7, which include the members of E. These sequences can be generalized to e1e2Ee4e5 and e1e2Ee4e7, which, in addition to the original sequences of the dataset, also include new sequences e1e2e6e4e5 and e1e2e3e4e7, not necessarily present in the original dataset. One of ordinary skill in the art will appreciate that the generalization of the dataset increases with the number of equivalence classes and the number of members in each equivalence class.

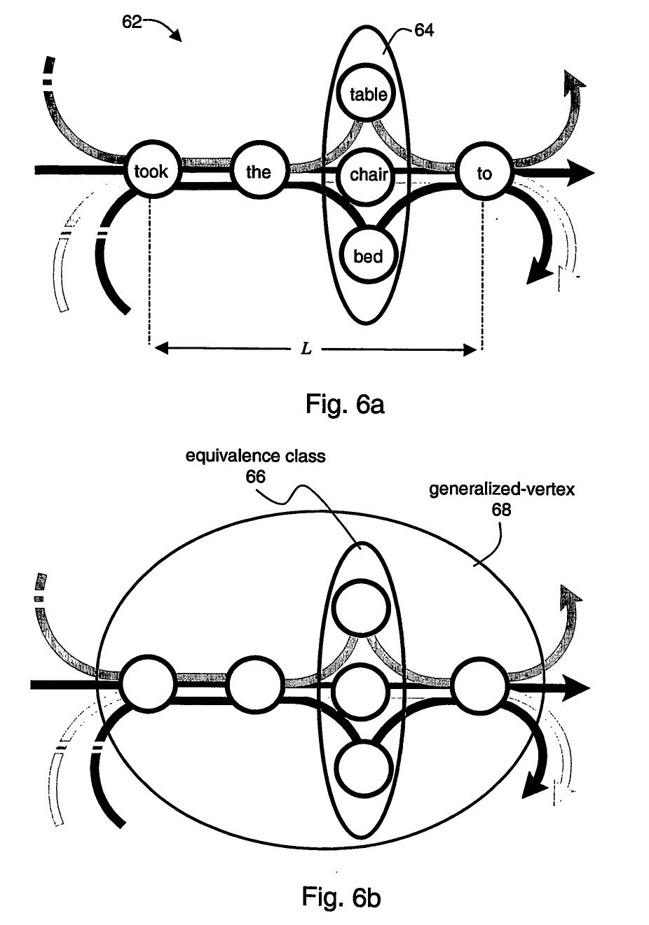

Following is a description of a method of generalizing the dataset, referred to hereinafter as method 50, and illustrated in the flowchart diagram of FIG. 5.

Hence, according to a preferred embodiment of the present invention, in a first step of method 50, designated by Block 52, significant patterns are preferably extracted from the dataset, for example, using selected steps of method 10 as further detailed hereinabove. Preferably, once the significant patterns are extracted, the dataset is redefined, as stated, by grouping tokens thereof according to the significant pattern to which they belong. In a second step of method 50, designated by Block 54, the dataset is searched for similarity sets.

As used herein, “similarity set” refers to a plurality of segments of different sequences, preferably of equal size, having a predetermined number of common tokens and a predetermined number of uncommon tokens. As further detailed hereinunder, selected steps of method 50 can be represented mathematically as operations performed on a graph having vertices and paths where each vertex represent one token of the lexicon and each path represent a sequence of the dataset. In conjunction to a graph, “similarity set” refers to a plurality of paths sharing a predetermined number of vertices within a given window of vertices. Denoting the window size (or, equivalently, the size of the segment) by L and the number of unshared vertices within the L-size window (or, equivalently, the number of uncommon tokens in the L-size segment) by S, the number of shared vertices (or common tokens) is L−S.

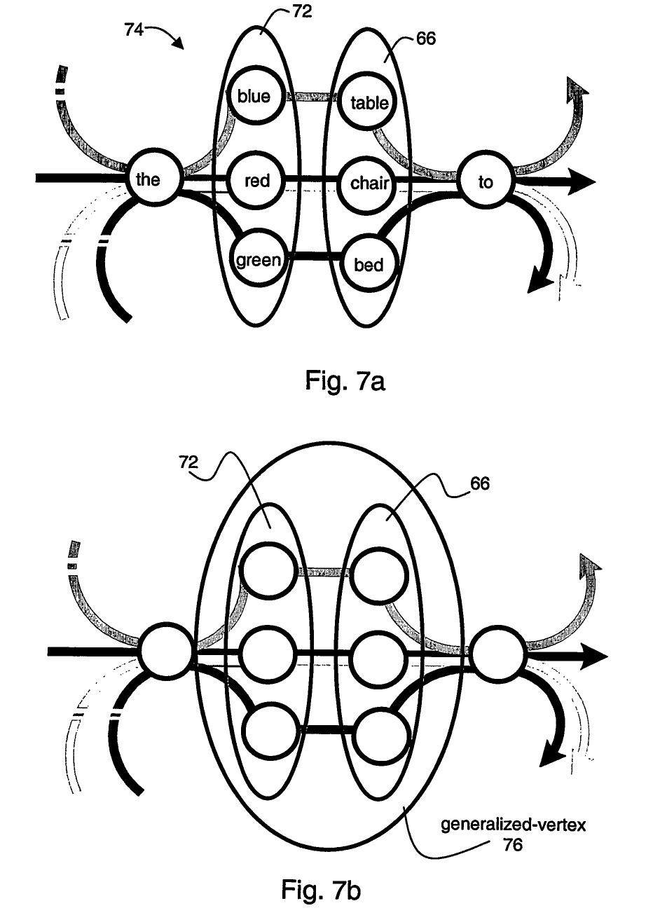

FIG. 6a is a schematic illustration of a portion of a graph constructed for a corpus of text in which the tokens are words and the sequences are sentences. Shown in FIG. 6a is a similarity set 62 of four paths sharing 3 vertices within a window of four vertices. A similarity set can thus be considered as some kind of a generalized search-path, which is allowed to branch at S given locations into other vertices of other paths sharing the prefix and suffix sub-paths of the original search-path within some limited window of a predetermined length, L. All the vertices at each branching location of the generalized search-path are collectively referred to hereinbelow as a slot of vertices. In the example shown in FIG. 6a, similarity set 62 comprises L−S=3 shared vertices within a window of size L=4, hence having S=1 slot (designated by numeral 64 in FIG. 6a).

Referring now again to FIG. 5, in a third step of method 50, designated by Block 56 the similarity sets are used for defining equivalence classes corresponding to slots of vertices which represent uncommon tokens of similarity sets.

As each similarity set comprises a plurality of paths, the definition of the equivalence classes is preferably done, using method 10 which, as stated, can be used for extracting one or more significant patterns from a search-path. Thus, according to a preferred embodiment of the present invention if a significant pattern emerges by searching along the generalized search-path, the set of all alternative vertices at the given location is defined as an equivalence class included within.

The significance test employed by method 10 in when searching for significant patterns of a similarity set can be generalized by defining the probabilities for a path with an open slot in terms of probabilities of the individual paths which form the similarity set. For example, consider a window of size L=3, composed of vertices e2, e3 and e4, with a slot at e3. The similarity set in this case consists of all the paths that share e2, e4 and branch into all possible vertices at location e3. According to a preferred embodiment of the present invention the probability P(e3|e2;e4) is defined as Σ_{β}=P(e3_{β}|e2;e4), where each P(e3_{β}|e2;e4) is calculated by considering a different path going through the corresponding e3_{β}. Similarly, for e2, e3, e4 and e5 the probability P(e5|e2e3e4) is preferably defined as Σ_{β}P(e5|e2;e3_{β};e4) and so on.

It will be appreciated that once an equivalence class is defined for a given path, the path is generalized, because, in addition to the original sequences that led to the existence of the equivalence class, other sequences can be generated from the path.

According to a preferred embodiment of the present invention the method may further comprise a step which is similar to the rewiring step introduced in method 10 above. More specifically, for each similarity set found to have at least one equivalence class therein, a generalized-vertex is defined, representing all vertices of a respective L-size window of the similarity set. FIG. 6b illustrates a generalized-vertex 68, defined for a similarity set having an equivalence class 66. Generalized-vertex 68 preferably represents the vertices of equivalence class 66 as well as all the vertices of the L-size window used to define equivalence class 66. The rewiring of the graph can be done in any rewiring mode including, without limitation, multiple, single and batch rewiring modes, as further detailed hereinabove.

It will be appreciated that the definition of generalized-vertex 68 with its enclosed equivalence class 66, also generalize all other paths participating in its definition. Thus, once the creation of equivalence classes is allowed, the dataset is generalized in the sense that many of its paths generate sequences that were not listed as sequences in the original dataset.

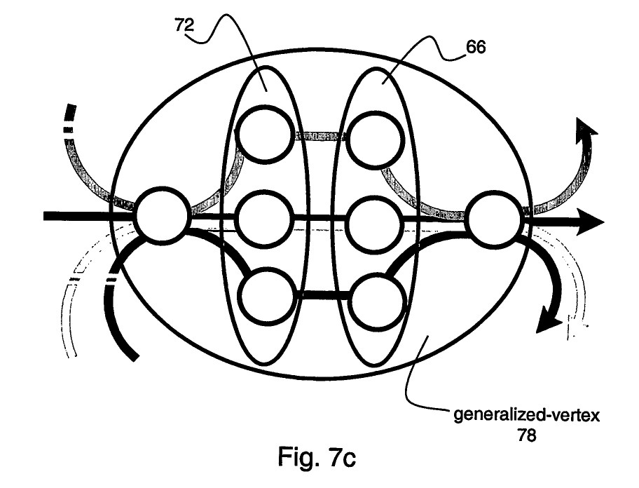

The generalization procedure can be taken one step further by allowing for multiple appearances of equivalence class within a generalized-vertex, even when such equivalence classes were not found in the search for shared vertices within the L-size window. Hence, according to a preferred embodiment of the present invention the method further comprises an additional step, designated by Block 58 of FIG. 5, in which equivalence classes are attributed to individual members of previously defined equivalence classes. More specifically, in this embodiment each path is searched for vertices identified as members of previously defined equivalence classes. Once such vertex is found, the respective equivalence class is attributed thereto. FIG. 7a illustrates a portion of a graph in which an equivalence class 72 is attributed to vertices identified as elements thereof Equivalence class 72 is adjacent to existing equivalence class 66 hence forming, together with the other vertices of the L-size window, a further generalized path designated by numeral 74.

The attribution of the equivalence classes is preferably subjected to a generalization test, so as to prevent over generalization of the dataset. This can be done, for example, by imposing a condition is which there is a sufficient number (say, larger than a generalization threshold, ω) of members of equivalence class 72 which already exist in path 74 at the time the aforementioned search is made. A typical value for the generalization threshold, ω, is from about 50% to about 65% of the size of the respective equivalence class (class 72 in the example of FIG. 6b).

In addition to the generalization test, the attribution of the equivalence classes can also be subjected to a significance test, e.g., one of the significance test of method 10. More specifically, path 74 can be used as a generalized search-path on which method 10 can be employed for extracting one or more significant patterns. According to a preferred embodiment of the present invention, class 72 is attributed to path 74 if a significant pattern emerges by searching along path 74.

Reference is now made to FIGS. 7b-c, which are illustrations of an additional step of method 50, according to a preferred embodiment of the present invention. Hence, once a particular path has been supplemented by an additional equivalence class, the graph or a portion thereof can be rewired, again, by defining a generalized-vertex including the existing equivalence class, the newly attributed equivalence class and, optionally, other vertices of the respective L-size window. Similarly to the above rewiring procedure, this procedure can be done in any rewiring mode including, without limitation, multiple, single and batch rewiring modes, as further detailed hereinabove.

FIG. 7b illustrates a generalized-vertex 76, representing the vertices of equivalence class 66 and the vertices of equivalence class 72. FIG. 7c illustrates a generalized-vertex 78, representing the vertices of equivalence class 66, the vertices of equivalence class 72 and the vertices of the L-size window used to define equivalence classes 66 and 72.

Preferably, the procedure of generalization and redefinition of the dataset is iteratively repeated. With each reiteration, new significant patterns and equivalence classes are defined in terms of previously defined significant patterns and equivalence classes as well as remaining tokens. These iterations are preferably performed over all sequences of the redefined dataset, time and again, until, say, no further significant pattern are found.

Thus, during the iterative process, the list of equivalence classes is updated continuously, and new significant patterns are found using the existing equivalence classes. For each set of candidate paths, the vertices are compared to one or more equivalence classes from the pool of existing equivalence classes. Because a vertex or a token can appear in several classes, different combinations of equivalence classes are checked, preferably while scoring each combination. The winner combination is preferably the largest class for which most of the members are found among the candidate paths in the set (the ratio between the number of members that have been found among the paths and the total number of members in the equivalence class is compared to the predetermined generalization threshold as one of the configuration acceptance criteria). If not all the members appear in an existing set, a new equivalence class can be created, with only those members that do. Thus, as the portion of the dataset that is processed increases, the dataset is enriches with new significant patterns and their accompanying equivalence classes, and the graph is bootstrapped with the pattern-vertices and generalized vertices. The recursive nature of this process allows method 50 to form more and more complex patterns, in a hierarchical manner.

One ordinarily skilled in the art will appreciate that the generalization procedure of method 50 depends, in principle, on the order in which the paths are selected to be searched and rewired. Hence, one can construct a set of graphs which differ from each other by the paths traversal order used in their construction. Each graph in the set corresponds to another generalized dataset.

According to a preferred embodiment of the present invention method 50 further comprises an optimization procedure in which selected steps (e.g., Blocks 54, 56 and 58) are repeated a plurality of times, while permuting a searching order of the similarity sets. Thus, a plurality of generalized datasets is obtained, each corresponding to a different generalization of the same input dataset.

Preferably, the optimization is achieved by calculating, for each generalized dataset, a generalization factor, which can be defined, for example, as a ratio between number of sequences of the generalized dataset and a number of sequences of the original dataset. The optimal generalized dataset can be selected as the generalized dataset corresponding to the maximal generalization factor.

Alternatively, the optimization can be achieved by calculating, for each generalized dataset a recall-precision pair. Recall and precision are effectiveness measures known in the art, in particular is the areas of data mining, database processing and information retrieval. Broadly, a recall value is the amount of relevant information (e.g., number of sequences) retrieved from the database divided by the amount of relevant information which exists in the database; and a precision value is the amount of relevant information retrieved from the database divided by the total amount of information which is retrieved. Hence, large value of the precision and small value of the recall corresponds to low productivity while small value of the precision and large value of the recall corresponds to over generalization. Thus, according to a preferred embodiment of the present invention the optimal generalized dataset is selected as the generalized dataset corresponding to optimal combination (e.g., multiplication) of the precision and recall values.

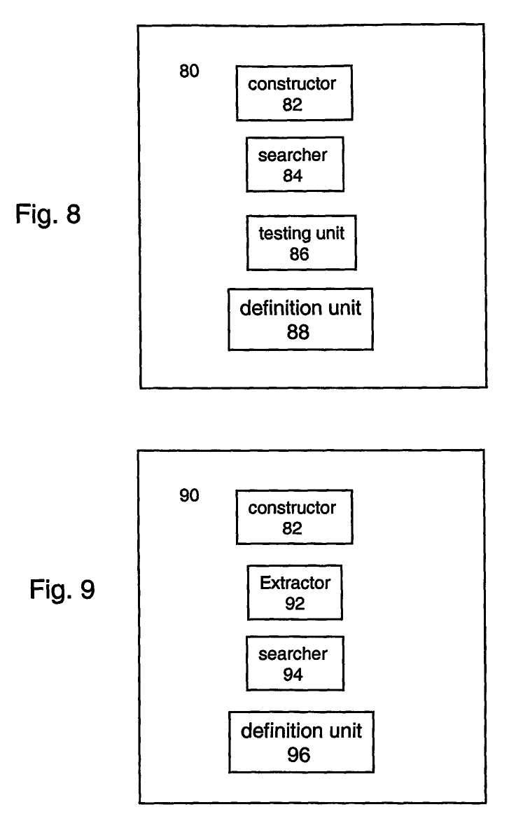

Reference is now made to FIG. 8, which is a simplified illustration of an apparatus 80 for extracting significant patterns from a dataset, according to a preferred embodiment of the present invention. Apparatus 80 can be used for executing selected steps of method 10, and preferably comprises a constructor 82, for constructing a graph representing the dataset as further detailed hereinabove. Apparatus 80 further comprises a searcher 84, for searching for partial overlaps between sequence and other sequences of the dataset, a testing unit 86, for applying significance tests on the partial overlaps, and a definition unit 88, for defining significant pattern of sequence, as further detailed hereinabove.

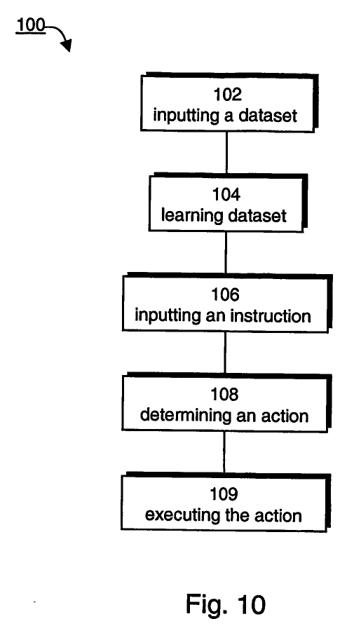

Reference is now made to FIG. 9, which is a simplified illustration of an apparatus 90 for generalizing a dataset, according to a preferred embodiment of the present invention Apparatus 90 can be used for executing selected steps of method 50 and preferably comprises constructor 82 as further detailed hereinabove. Apparatus 90 may further comprises an extractor 92 for extracting significant patterns, e.g., by executing selected steps of method 10. Hence, the principles and operations of extractor 92 are preferably similar to the principles and operations of apparatus 80. Apparatus 90 can further comprise a searcher 94, for searching over the dataset for similarity sets, and a definition unit 96, for defining equivalence classes as further detailed hereinabove.

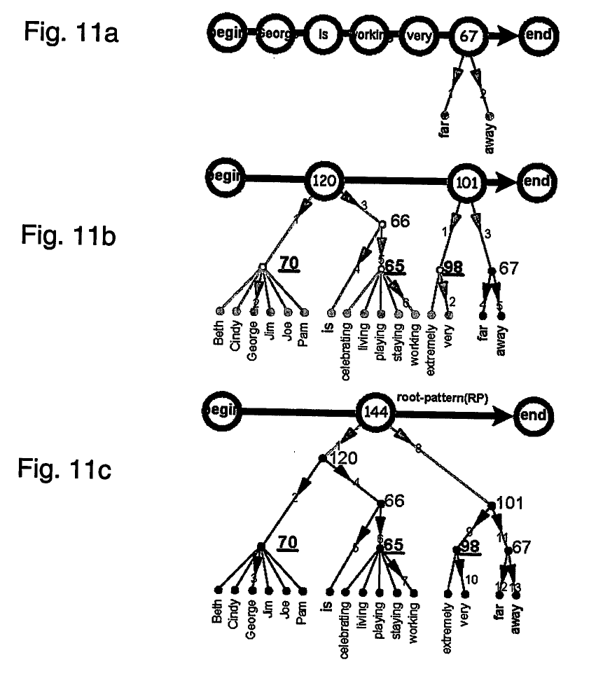

According to an additional aspect of the present invention there is provided a method 100 of executing at least one action based on at least one instruction. Method 100 comprises the following method steps which are illustrated in the flowchart diagram of FIG. 10.

Hence, in a first step, designated by Block 102 a dataset of sequences defined over a lexicon of tokens is inputted. In a second step, designated by Block 104 the dataset is learned, for example using selected steps of method 50, so as to provide a generalized dataset. In a third step, designated by Block 106 the instruction is inputted, for example as a written text, a speech, a series of keyboard strokes and the like. In a fourth step, designated by Block 108 the inputted instruction is analyzed and compared to the sequences of the generalized dataset so as to determine the appropriate action corresponding to the instruction, and in a fifth step, designated by Block 109 the action is executed. The first two steps of method 100 (Blocks 102 and 104) are preferably executed once for each dataset, while the other steps (Blocks 106, 108 and 109) can executed more than one time, thereby allowing execution of multiple instructions.

The above methods and apparati thus enable the construction of a graph having many paths, in principle of the same order of magnitude as the original number of paths, yet its overall structure is much reduced, since many of the vertices and sub-paths are merged to pattern-vertices. The pattern-vertices that are left in the final format of the graph are referred to hereinafter as “root-patterns.” The set of all significant patterns and equivalence classes that form the generalized dataset can be represented hierarchically as a forest of multilevel trees. Each tree can represent a pattern of tokens of the generalized dataset, whereby child nodes, appearing on the leaf level of the tree, correspond to tokens, and parent nodes, appearing on the partition levels, correspond to significant patterns or equivalence classes.

As stated in the Introduction section hereinabove, prior art unsupervised learning techniques suffer from the limitation that the closeness between grammars is un-decidable. A standard paradigm for grammar induction involves a teacher that produces a sequence of strings generated by its grammar, G₀, and a learner that uses the resulting corpus to construct a grammar, G, aiming to approximate G₀. According to a preferred embodiment of the present invention the generativity of the generalized dataset can be tested evaluating precision and recall values of teacher and learner test corpora as further detailed in the Examples section that follows.

A particular feature of the present embodiment is the ability to make an educated guess as to the meaning of unfamiliar sequences, by considering the patterns that become active. More specifically, novel sequences can be characterized by distributed representations formed in terms of activities of existing patterns. Hence, according to a preferred embodiment of the present invention the activities of each sequence are calculated by propagating upwards on each pattern, preferably from its leaf level to its pattern-vertex. For example, denoting a novel sequence of length k by s₁, . . . , sₖ, the initial activities, aⱼ, of the terminals eⱼ can be probabilistically defined as αⱼ=maxₗ₌1 . . . k{P(sₗ,eⱼ) logP(sₗ,eⱼ)/(P(sₗ)P(eⱼ)}, where P(sₗ,eⱼ) is the joint probability for both sₗ and eⱼ to appear in the same equivalence class, and P(sₗ), P(ej) are, respectively, the probabilities of sₗ and eⱼ to appear in any equivalence class. For an equivalence class, the value propagated upwards is preferably the strongest non-zero activation of its members; for a pattern, it is preferably the average weight of the child nodes, on the condition that all the children are activated by adjacent inputs.

Once constructed in its forest representation, the generalized dataset can be stored in appropriate memory media for future use. According to a preferred embodiment of the present invention the memory media can be any memory media known to those skilled in the art, capable of storing the generalized dataset either in a digital form or in an analog form. Preferably, but not exclusively, the memory is removable so as to allow plugging the memory into a host (e.g., a processing system), thereby allowing the host to store the generalized dataset in it or to retrieve the generalized dataset from it.

Examples for memory media which may be used include, but are not limited to, disk drives (e.g., magnetic, optical or semiconductor), CD-ROMs, floppy disks, flash cards, compact flash cards, miniature cards, solid state floppy disk cards, battery-backed SRAM cards and the like.

According to a preferred embodiment of the present invention, the generalized dataset is stored in the memory media in a retrievable format so as to provide accessibility to the stored data. Preferably, information is retrieved from the generalized dataset either automatically or manually. That is to say that the generalized dataset may be searched by an appropriate set of search codes, or alternatively, a user may scan the entire generalized dataset or a portion of it, so as to find a match for the desired sequence.

It is appreciated that in all the above embodiments, the generalized dataset can be stored in the memory media in an appropriate displayable format, either graphically or textually. Many displayable formats are presently known, for example, TEXT, BITMAP™, DIF™, TIFF™, DIB™, PALETTE™, RIFF™, PDF™, DVI™ and the like. However it is to be understood that any other format that is presently known or will be developed during the life time of this patent, is within the scope of the present invention.

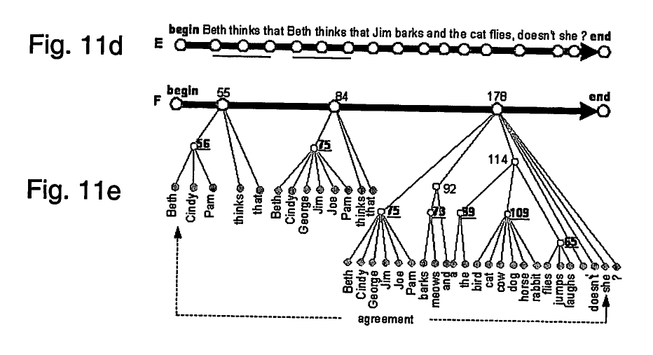

Reference is now made to FIGS. 11a-c, which illustrate nested relationships between significant patterns and equivalence classless in a tree format, according to a preferred embodiment of the present invention. FIG. 11a shows a simple relationship of a sequence containing several tokens and one significant pattern (designated by blob 67 in FIG. 11a) of two tokens. Such relationships are typically obtained in early iterations of the generalization procedure. A further reiteration is shown in FIG. 11b, where significant pattern 67 is found to belong to another significant pattern, designated by blob 101 in FIG. 11b, together with an equivalence class, designated by blob 98. Also shown in FIG. 11a is an additional significant pattern 120 on the same partition level as significant pattern 101, parenting two equivalence classes, 70 and 66. Whereas equivalence class 70 is partitioned to child nodes on the leaf level of the tree, equivalence class 66 is partitioned to one child node and one parent node, representing another equivalence class, designated by blob 65. A typical final tree is shown in FIG. 11c, where a root-pattern 144, parenting the aforementioned significant patterns 120 and 101, is left between the “begin” vertex and the “end” vertex of the graph from which the tree is constructed.

In general, any path on the graph can be represented as one root-pattern, or a set of consecutive root-patterns and some of the original tokens. To generate a sentence from a given path, each root-pattern is preferably considered in its tree format. The tree can be constructed to be read from top to bottom and from left to right, where, preferably, only one of the children of each equivalence class is selected to generate a sequence, appearing on the leaf-level of the tree.

The tree representation can also be described in terms of a set of rules specifying the relations between all the significant patterns and equivalence classes that appear in the tree. The set of all trees, generated by all root-patterns, can thus be viewed as a large context free grammar (CFG) associated with the graph.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

### Example 1

Following is a detailed generalization algorithm which can be used for generalizing a dataset, according to a preferred embodiment of the present invention For a better understanding of the according to the presently preferred embodiment of the invention, the algorithm is explained for the case in which the dataset is corpus of text having a plurality of sentences defined over a lexicon of words.

1. Initialization: load all sentences as paths onto a graph whose vertices are the unique words of the corpus.

2. Pattern Distillation:

for each path

2.1 find the leading significant pattern:

define the path as a search-path and perform method 10 on the search-path by considering all search segments (i,j), j>i, starting P_{R} at eᵢ and P_{L} at eⱼ; choose out of all segments the leading significant pattern, P, for the search-path; and

2.2 rewire graph:

create a new vertex corresponding to P and replace the string of vertices comprising P with the new vertex P using the context-free embodiment or the context-sensitive embodiment

3. Generalization—First Step:

for each path

3.1 slide a context window of size L along the search-path from its beginning vertex to its end; at each step i (i=1, . . . , K−L−1 for a path of length K) examine the generalized search-paths:

for all j=i+1, . . . , i+L−2 do

3.1.1 define a slot at location j;

3.1.2 define the generalized path consisting of all paths that have identical prefix (at locations i to j−1) and identical suffix (at locations j+1 to i+L−1); and

3.1.2 execute method 10 on the generalized path;

3.2 choose the leading P for all searches performed on each generalized path;

3.3 for the leading P define an equivalence class E consisting of all the vertices that appeared in the relevant slot at location j of the generalized path; and

3.3 rewire graph:

create a new vertex corresponding to P, and replace the string of vertices it subsumes with the new vertex P using the context-free embodiment or the context-sensitive embodiment.

4. Generalization—Bootstrap:

for each path

4.1 slide a context window of size L along the search-path from its beginning vertex to its end; at each step i (i=1, . . . , K−L−1 for a path of length K)

do:

4.1.1 construct generalized search-path p for all slots at locations j,j=i+1, . . . , i+L−2, do

(i) consider all possible paths through these slots; and

(ii) at each slot j compare the set of all encountered vertices to the list of existing equivalence classes, selecting the one E(j) that has the largest overlap with this set, provided it is larger than a minimum overlap ω;

4.1.2 reduce generalized search-path:

for each k,k=i+1, . . . , i+L−2 and all j,j=i+1, . . . , i+L−1 such that j≠k do:

(i) consider the paths going through all the vertices in k that belong to E(j) for all j, if no E(j) is assigned to a particular j, choose the vertex that appears on the original search-path at location j; and

(ii) execute method 10 on the resulting generalized path;

4.1.3 extract the leading P, which may include one new equivalence class E, or none; and

4.1.4 rewire graph

create a new vertex corresponding to P either by replacing the string of vertices subsumed by P with the new vertex P using the context-free embodiment or the context-sensitive embodiment.

5. Reiteration:

Repeat step 4 until no further significant patterns is found.

### Example 2

An experiment involving a self-generated context free grammar (CFG) with 53 words and 40 rules has been performed using the algorithm described in Example 1, with ω=0.65, η=0.6 and L=5. The training corpus contained 200 sentences, each with up to 10 levels of recursion. After training, a learner-generated test corpus Cₗₑₐᵣₙₑᵣ of size 1000 was used in conjunction with a test corpus C_{teacher} of the same size produced by the teacher, to calculate precision and recall. The precision was defined conservatively as the proportion of Cₗₑₐᵣₙₑᵣ accepted by the teacher, and the recall was defined as the proportion of C_{teacher} accepted by the learner, where a sentence is accepted if it is covered precisely by one of the sentences that can be generated by the teacher or learner respectively.

The experiment included four runs, each of 30 trials, as follows: in a first run the context-free embodiment was employed; in a second run, the context-sensitive embodiment was employed; in a third run the context-free embodiment was employed, starting from a letter level and training corpora in which all spaces between words were omitted; and in a fourth run a “semantically supervised” version of the context-free embodiment was employed in which the equivalence classes were given to the learners, following the known structure of the self-generated CFG.

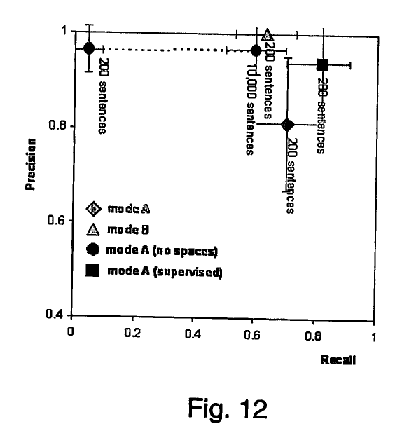

FIG. 12 shows the best precision and recall values obtained for the four runs. The runs are referred to in FIG. 12 by “mode A” (first) “mode B” (second) “mode A no spaces” (third) and “mode A supervised” (fourth), respectively designated by diamond, triangle, circle and square.

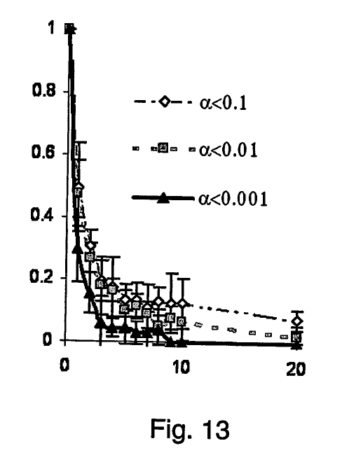

FIG. 13 shows results of random pairwise interchanges of words in the various sentences, performed on the corpus generated by the teacher. The interchanges were performed for a fixed cutoff η=0.6 and varying values for the predetermined threshold, α. As shown in FIG. 13, the number of significant patterns reduces considerably as a function of the syntactic errors induced by the interchanges.

### Example 3

As stated, the generalization procedure of the algorithm is sensitive to the order in which the paths are selected to be searched and rewired. To assess the order dependence and to mitigate it, multiple learners were trained on different order-permuted versions of a corpus generated by the teacher.

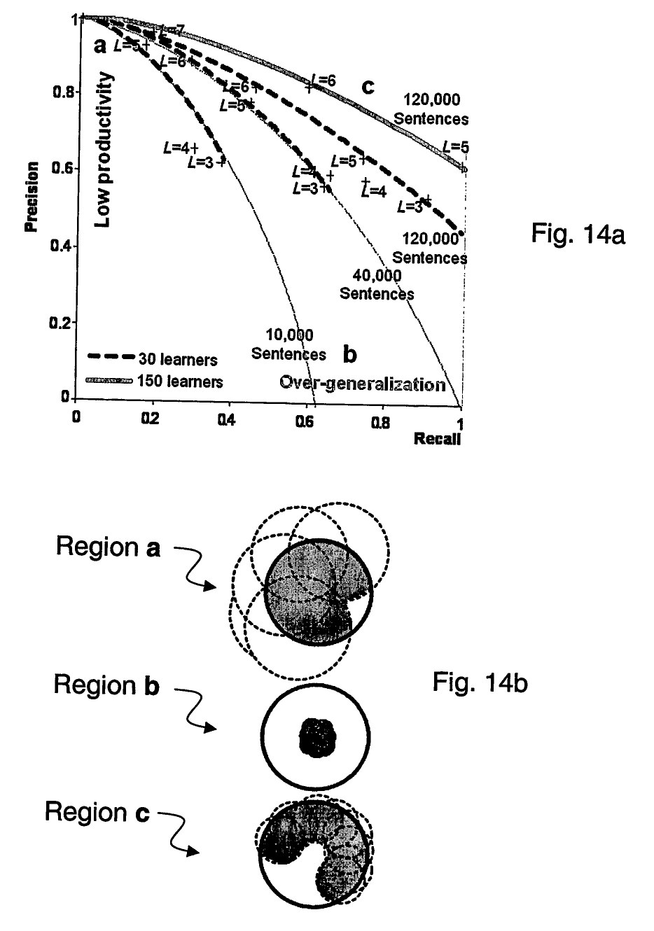

FIGS. 14a-b show precision and recall of multiple learners training for a 4592-rule ATIS CFG [B. Moore and J. Carroll, “Parser Comparison—Context-Free Grammar (CFG) Data, http://www.informatics.susx.ac.uk/research/nlp/carroll/cfg-resources, 2001]. Shown in FIGS. 14a-b are results for corpus sizes of 10,000, 40,000 and 120,000 sentences, and context windows of sizes L=3, 4, 5, 6 and 7. For an ensemble of learners, precision was calculated by taking the mean across individual graphs; for recall, acceptance by one learner sufficed. There are three regions on the precision-recall plot of FIG. 14a, designated a, b and c. Region a is typical for very lax learner, which may raise the recall measure, but the system would pay for this dearly in precision, thus, referring to FIG. 14b, such learners tend to over generalize the dataset, and a large portion of the sentences which they generate are rejected by the teacher. Region b is typical for too strict learners having high precision by low recall, thus, referring to FIG. 14b, such learners generate insufficient number of sentences. Region c represents learners which are neither lax nor strict, thus, referring to FIG. 14b, the number of sentences which are generated by these learners is similar to the number of sentences recognized by the teacher. The recall measure increases logarithmically with the number of learners. The best results were obtained for 150 learners of a corpus of size 120,000 sentences, and window size between 5 and 6.

### Example 4

The algorithm described in Example 1 was applied to a natural language corpus of ATIS-NL [B. Moore and J. Carroll, supra] which consists of 13,700 sentences hence only low values of recall can be expected. Ten humans were asked to rate the acceptability of original ATIS-NL sentences with those generated by a generalized dataset thereof obtained by employing the method of the presently preferred embodiment of the invention.

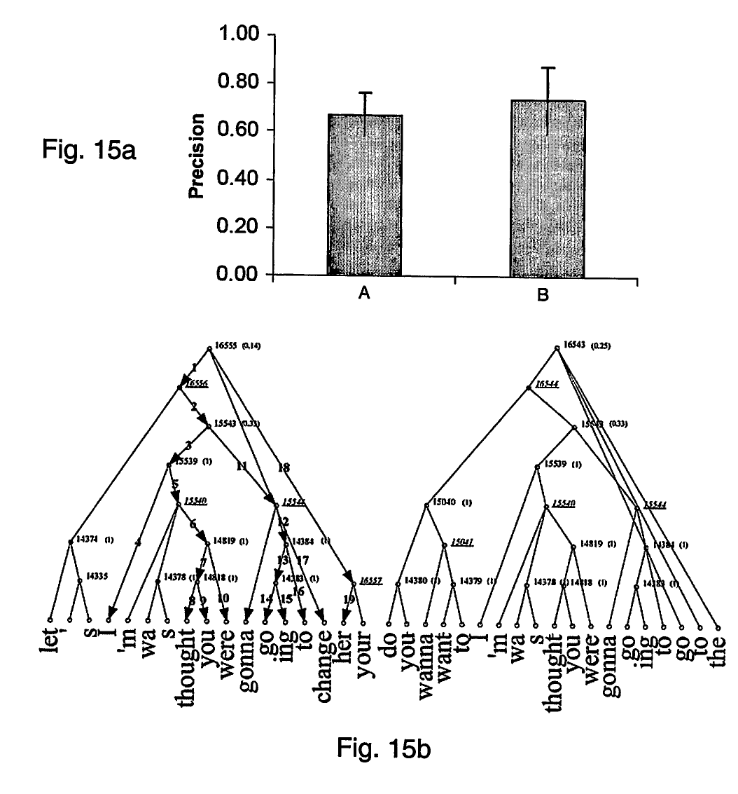

FIG. 15a shows the assessments of the ten humans for the generalized dataset and the original dataset, respectively designated by columns “A” and “B” in FIG. 15a As shown, the grammaticality assessments of both datasets are on the same level, on average.

The algorithm was successfully also applied to raw transcriptions of child-directed speech [B. MacWhinney and C. Snow, “The Child Language Exchange System (CHILDES),” Journal of Computational Lingustics, 12:271-296, 1985]. Unlike the artificial ATIS-NL dataset, where the sentences are by and large well-formed and complete, in the child-directed speech sentences are often fragmented and grammatical irregularities abound.

FIG. 15b, shows a portion of a forest representation of the generalized dataset obtained from the child-directed speech. As shown, the present embodiment was capable of finding significant patterns and producing semantically adequate corresponding equivalence classes.

### Example 5

A Grammaticality judgment test, according to the guidelines of E. Carrow-Woolfolk, in a book entitled “Comprehensive Assessment of Spoken Language (CASL),” published by AGS Publishing, Circle Pines, Minn., 1999 consists of 57 sentences, and is administered as follows: a sentence is read to the child, who then has to decide whether or not it is correct. If not, the child has to suggest a correct version of the sentence. For every incorrect sentence, the test lists 2-3 acceptable correct ones.

In an experiment performed, according to a preferred embodiment of the present invention, 11 out of the 57 sentences that were correct to begin with were omitted. The remaining 46 incorrect sentences and their corrected versions were scored by the algorithm of Example 1, which was trained on a 300,000-sentence corpus from the CHILDES; the highest scoring sentence in each trial was interpreted as the model's choice. 17 of the test sentences were labeled correctly, giving the algorithm of Example 1 a score of 108 (where 100 is the norm) for the age interval 7-0 through 7-2. A reverse lookup in the CASL norm table attributes this score to a normal child in the age interval 8-3 through 8-5.

### Example 6

It has been shown [R. L. Gómez, Variability and detection of invariant structure,” Psychological Science, 13:431-436, 2002] that the ability of subjects to learn a language L1 of the form {aXd, bXe, cXf}, as measured by their ability to distinguish it implicitly from L2={aXe, bXf, cXd}, depends on the amount of variation introduced at X (symbols a through f stand for nonce words such as pel, vot, or dak, whereas X denotes a slot in which a subset of 24 other nonce words may appear).

According to a preferred embodiment of the present invention, the so-called non-adjacent dependencies that arise in such data translate into patterns with embedded equivalence classes. The above study was replicated by training the algorithm of Example 1 on 432 strings from L1, with |X|=2, 6, 12, 24. The stimuli were the same strings as in the original experiment, with the individual letters serving as the basic symbols. A subsequent test resulted in a perfect acceptance of L1 and a perfect rejection of L2.

Training with the original words (rather than letters) as the basic symbols resulted in L2 rejection rates of 0%, 55%, 100% and 100%, for |X|=2, 6, 12, 24, respectively. Thus, the method of the present embodiment is capable of mirroring the performance of the human subjects.

### Example 7

The algorithm described in Example 1 was applied to six translations (Chinese, Spanish, French, English, Swedish and Danish), of the Bible (66 books containing 33,000 sentences). The generalized dataset was represented in a forest representation, according preferred embodiments of the invention.

The obtained forest was analyzed by categorizing all the significant patterns that are extracted from the data according to three categories: (i) other patterns, P, (ii) equivalence classes, E, and (iii) original words or terminals T, of the respective tree.

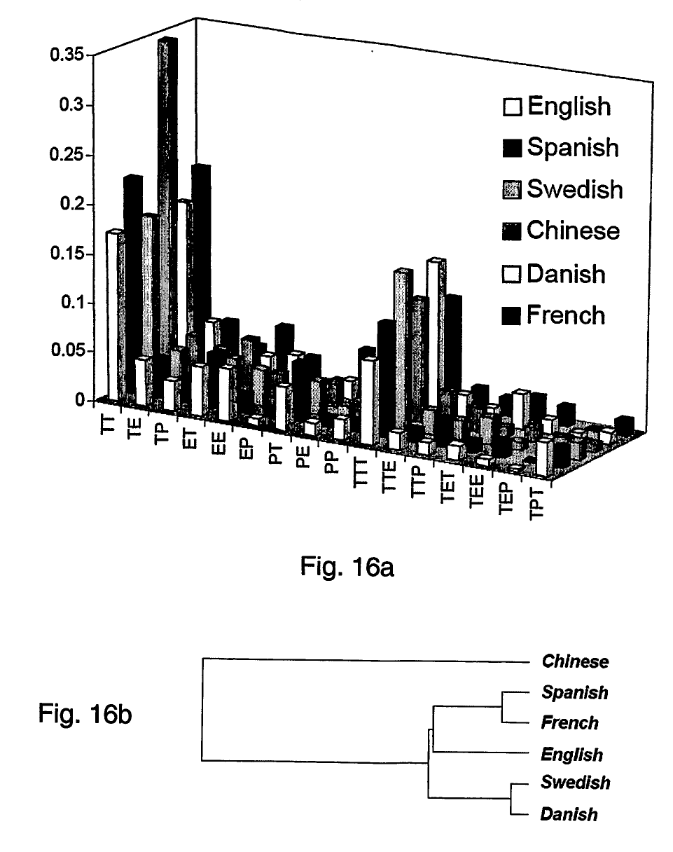

FIG. 16a is a histogram showing the proportions of patterns defined in terms of the three categories. Specifically, FIG. 16a shows percentages of patterns, described in terms of various P, E and T combinations, e.g., TT, TE, TP, and the like. All natural languages have a relatively large percentage of patterns that fall into TT and TTT categories (known as collocations), as demonstrated in FIG. 16.

FIG. 16b is a dendrogram representation of the histogram of FIG. 16a. The dendrogram representation can be considered as a measure for relative syntactic proximity between the six languages. As shown in FIG. 16b, the relative syntactic proximities correspond to the expected pattern of typological relationships suggested by classical linguistic analyses based on similarity of vocabularies.

### Example 8

The algorithm described in Example 1 was applied to a dataset of about 4777 C. Elegans genes obtained from http://hgdownload.cse.ucsc.edu.

The genes were represented in terms of 64 words constructed from triplets of nucleotides (codons). This representation depends, of course, on the knowledge of the starting point of the gene, the beginning of an Open Reading Frame (ORF). The dataset was analyzed in terms of three ORFs, defined as follows: ORF0=cgc ttt agc aat taa . . . , coinciding with the known ORF; ORF1=c gct tta gca att aag . . . , deviating from ORF0 by one location; and ORF2=cg ctt tag caa tta agc . . . , deviating from ORF0 by two locations.

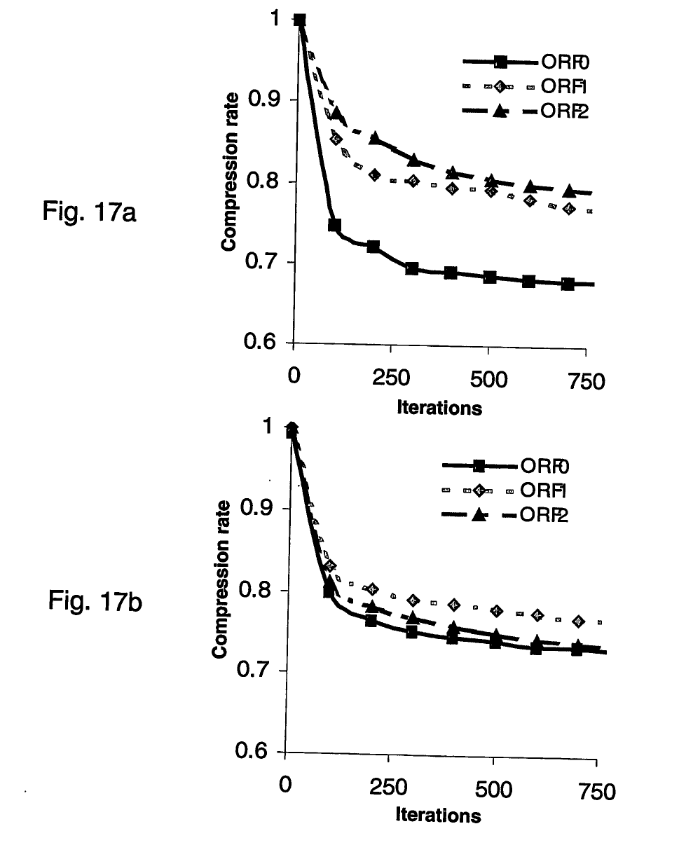

FIGS. 17a-b show the attained compression degree for ORF0, ORF1 and ORF2, as a function of the number of iterations, where FIG. 17a is for the first exon of the genes and FIG. 17b is for 500 bases. As shown in Figures a-b, the highest compression is obtained for ORF0, thus indicating what is the correct reading frame.

### Example 9

The purpose of the present experiment was to evaluate the ability of root patterns found by the algorithm described in Example 1 to support functional classification of proteins. The algorithm of Example 1 was applied to a dataset of 6751 proteins of the oxidoreductases super-family obtained from SwissProt™ database, Release 40.0 [available from http://www.expasy.org/sprot/].

The function of an enzyme is encoded by the Enzyme Commission (EC) number, which has the form: n1.n2.n3.n4, whereby for the oxidoreductases super-family n1=1. Sequences with double annotations were not included in the experiment.

Root patterns, extracted in accordance with the presently preferred embodiment of the invention were used by a linear Support Vector Machine (SVM) classifier to classify the proteins into functional families. The linear SVM classifier was trained on positive and negative examples of proteins of each functional family, 75% of the examples were used for training, and the remainder for testing the classifier. Classification was tested at level 2 (EC 1.x) and level 3 (EC 1.x.x).

Performance was defined as Q=(TP+TN)/(TP+TN+FP+FN), where TP, TN, FP and FN are, respectively, the number of true positive, true negative, false positive and false negative outcomes.

For comparison, the performance of a SVM-PRot™ system [Cai C Z, Han L Y, Ji Z L, Chen X, Chen Y Z, “SVM-Prot: Web-based support vector machine software for functional classification of a protein from its primary sequence,” Nucleic Acids Res., 31(13):3692-7, (2003)].

Note that whereas the SVM-PRot™ system is based on input features such as hydrophobicity, normalized Van der Waals volume, polarity, polarizability, charge, surface tension, secondary structure and solvent accessibility, the method of the present embodiment use only the amino-acid sequence data, from which the structure was extracted.

High correlations were found between patterns extracted by the present embodiment and specific families of enzymes. A representative example includes, without limitation, the EC family 1.6.5.3 to which several extracted patterns were found to be unique.

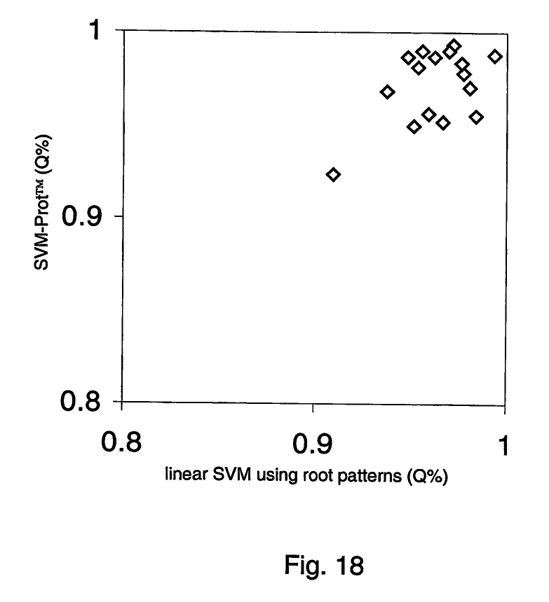

FIG. 18 shows functional protein classification of 15 EC classes, level 2. Sown in FIG. 18 are Q-values of the SVM-Prot™ system on the ordinate, and Q-values of the linear SVM classifier using the root patterns of the present embodiment on the abscissa. The correlations between the Q-values are vivid.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-164. (canceled)

165. A method of extracting significant patterns from a dataset having a plurality of sequences defined over a lexicon of tokens, the method comprising, for each sequence of the plurality of sequences: searching for partial overlaps between said sequence and other sequences of the dataset, applying a significance test on said partial overlaps, and defining a most significant partial overlap as a significant pattern of said sequence, thereby extracting significant patterns from the dataset.

166. The method of claim 165, wherein said search for partial overlaps is by constructing a graph having a plurality of paths representing the dataset and searching for partial overlaps between paths of said graph.

167. The method of claim 166, wherein said search for partial overlaps between paths of said graph comprises:
defining, for each path, a set of sub-paths of variable lengths, thereby defining a plurality of sets of sub-paths; and
for each set of sub-paths, comparing each sub-path of said set with sub-paths of other sets.

168. The method of claim 166, wherein said graph comprises a plurality of vertices, each representing one token of the lexicon, and further wherein each path of said plurality of paths comprises a sequence of vertices respectively corresponding to one sequence of the dataset.

169. The method of claim 166, further comprising calculating, for each path, a set of probability functions characterizing said partial overlaps.

170. The method of claim 165, further comprising grouping at least a few tokens of said significant pattern, thereby redefining the dataset.

171. The method of claim 165, wherein the dataset comprises a corpus of text.

172. The method of claim 165, wherein the dataset comprises a protein database.

173. The method of claim 165, wherein the dataset comprises a DNA database.

174. The method of claim 165, wherein the dataset comprises an RNA database.

175. The method of claim 165, wherein the dataset comprises a recorded speech.

176. The method of claim 165, wherein the dataset comprises a corpus of music notes.

177. The method of claim 165, wherein the dataset comprises a weblog database.

178. The method of claim 165, wherein the dataset comprises trajectory records of a transportation network.

179. The method of claim 165, wherein the dataset comprises activity records of a self-active system.

180. The method of claim 165, wherein the dataset comprises records of operational steps in a technical process.

181. A method of generalizing a dataset having a plurality of sequences defined over a lexicon of tokens, the method comprising:
searching over the dataset for similarity sets, each similarity set comprising a plurality of segments of size L having L−S common tokens and S uncommon tokens, each of said plurality of segments being a portion of a different sequence of the dataset; and
defining a plurality of equivalence classes corresponding to uncommon tokens of at least one similarity set, thereby generalizing the dataset.

182. The method of claim 181, wherein said definition of said plurality of equivalence classes comprises, for each segment of each similarity set:
extracting a significant pattern corresponding to a most significant partial overlap between said segment and other segments or combination of segments of said similarity set, thereby providing, for each similarity set, a plurality of significant patterns; and
using said plurality of significant patterns for classifying tokens of said similarity set into at least one equivalence class;
thereby defining said plurality of equivalence classes.

183. The method of claim 182, further comprising, prior to said search for said similarity sets:
extracting a plurality of significant patterns from the dataset, each significant pattern of said plurality of significant patterns corresponding to a most significant partial overlap between one sequence of the dataset and other sequences of the dataset; and
for each significant pattern of said plurality of significant patterns, grouping at least a few tokens of said significant pattern, thereby redefining the dataset.

184. The method of claim 181, further comprising, for each similarity set having at least one equivalence class, grouping at least a few tokens of said similarity set thereby redefining the dataset.

185. The method of claim 181, further comprising for each sequence, searching over said sequence for tokens being identified as members of previously defined equivalence classes, and attributing a respective equivalence class to each identified token, thereby generalizing said sequence, thereby further generalizing the dataset.

186. The method of claim 183, further comprising constructing a graph having a plurality of paths representing the dataset, wherein each extraction of significant pattern is by searching for partial overlaps between paths of said graph.

187. An apparatus for generalizing a dataset having a plurality of sequences defined over a lexicon of tokens, the apparatus comprising:
(a) a searcher, for searching over the dataset for similarity sets, each similarity set comprising a plurality of segments of size L having L−S common tokens and S uncommon tokens, each of said plurality of segments being a portion of a different sequence of the dataset; and
(b) a definition unit, for defining a plurality of equivalence classes corresponding to uncommon tokens of at least one similarity set, thereby generalizing the dataset.

188. The apparatus of claim 187, further comprising an extractor, capable of extracting, for a given set of sequences, a significant pattern corresponding to a most significant partial overlap between one sequence of said set of sequences and other sequences of said set of sequences, thereby providing, for said given set of sequences, a plurality of significant patterns.

189. The apparatus of claim 188, wherein said given set of sequences is a similarity set, hence said plurality of significant patterns corresponds to said similarity set.

190. The apparatus of claim 188, wherein said classifier is designed for selecting a leading significant pattern of said similarity set, and defining uncommon tokens of segments corresponding to said leading significant pattern as an equivalence class.

191. The apparatus of claim 188, wherein said given set of sequences is the dataset, hence said plurality of significant patterns corresponds to the dataset.

192. The apparatus of claim 188, further comprising a first grouper for grouping at least a few tokens of each significant pattern of said plurality of significant patterns.

193. The apparatus of claim 187, further comprising a second definition unit having a second searcher, for searching over each sequence for tokens being identified as members of previously defined equivalence classes, wherein said second definition unit is designed to attribute a respective equivalence class to each identified token.

194. The apparatus of claim 188, further comprising a constructor, for constructing a graph having a plurality of paths representing the dataset.
